(19) United States
(12) Patent Application Publication
(10) Pub. No.: US 2023/0399710 A1
(43) Pub. Date: Dec. 14, 2023

(54) PROCESSES FOR PURIFYING IRON-BEARING MATERIALS

(71) Applicant: FORM ENERGY, INC., Somerville, MA (US)

(72) Inventors: Michael Andrew GIBSON, Philadelphia, PA (US); Danielle Cassidy SMITH, Cambridge, MA (US); Yet-Ming CHIANG, Weston, MA (US); Kjell William SCHRODER, Medford, MA (US); Olivia Claire TAYLOR, Somerville, MA (US); Vincent Chevrier, Charlotte, NC (US)

(21) Appl. No.: 18/165,186

(22) Filed: Feb. 6, 2023

Related U.S. Application Data
(60) Provisional application No. 63/307,462, filed on Feb. 7, 2022.
(60) Provisional application No. 63/365,297, filed on May 25, 2022.

(51) Int. Cl. C21C 1/04

(52) U.S. Cl. CPC C21C 1/04; H01M 4/139

(57) ABSTRACT

Various embodiments include processes for purifying and/or preparing iron-bearing materials. Various embodiments include purification and/or preparation of iron ores, iron, and their intermediates. Various embodiments include processes for purifying iron-bearing materials comprising leaching one or more soluble species of impurities out of iron-bearing materials using a leaching solution comprising fluorine.

### RELATED APPLICATIONS

This application claims the benefit of priority to U.S. Provisional Patent Application No. 63/307,462 entitled “PROCESSES FOR PURIFYING IRON-BEARING MATERIALS” filed Feb. 7, 2022 and to U.S. Provisional Patent Application No. 63/365,297 entitled “PROCESSES FOR PURIFYING IRON-BEARING MATERIALS” filed May 25, 2022, the entire contents of both of which are hereby incorporated by reference for all purposes.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultra-long duration (collectively, >8 h) energy storage systems.

Iron-based negative electrode electrochemical systems (or said another way iron-based anode electrochemical systems) are attractive options for electrochemical energy storage. However, it can be difficult to achieve high performance in iron-based negative electrodes, especially at lower discharge rates, such as discharge rates associated with full discharge times of greater than about 8 hours, such as 8 hours, more than 8 hours, 8-16 hours, 16 hours, more than 16 hours, 16-24 hours, 24 hours, more than 24 hours, 24-30 hours, 30 hours, more than 30 hours, etc. Sponge iron is an excellent candidate for an iron-based negative electrode due to sponge iron's costs, but electrodes fabricated from sponge iron can face challenges in realizing performance increases, despite promising material properties of sponge iron.

Iron-based alkaline electrochemical systems are attractive options for long duration energy storage at grid scale due to the low entitlement cost of iron and alkaline electrolyte components. Grid scale energy storage requires the use of raw materials which are lower cost, and thus can be of lower purity, than traditional iron electrode materials. Impurities can be detrimental to the performance of iron electrodes. It is difficult to remove some of these impurities from iron-bearing materials at low cost and in a highly-scalable manner, resulting in high-performance, low-cost iron materials.

Thus, there exists a need to remove impurities from iron-bearing materials at low cost and in a highly-scalable manner, resulting in high-performance, low-cost iron materials. Some specific impurities of interest to remove are silica (SiO₂)(also referred to as silicon dioxide), alumina (Al₂O₃)(also referred to as aluminum oxide), magnesia (MgO)(also referred to as magnesium oxide), calcia (CaO)(also referred to as calcium oxide), and manganese oxides.

This Background section is intended to introduce various aspects of the art, which may be associated with embodiments of the present inventions. Thus, the foregoing discussion in this section provides a framework for better understanding the present inventions, and is not to be viewed as an admission of prior art.

### SUMMARY

Various embodiments include processes for purifying and/or preparing iron-bearing materials. Various embodiments include purification and/or preparation of iron ores, iron, and their intermediates. Various embodiments include processes for purifying iron-bearing materials comprising leaching one or more soluble species of impurities out of iron-bearing materials using a leaching solution comprising fluorine.

Various embodiments include processes for removing impurities, such as silica, alumina, magnesia, manganese oxides, and/or calcia, from iron-bearing materials. Various embodiments may include one or more materials and/or processes for leaching soluble species out of iron-based materials.

Various embodiments may include alkaline leaching techniques for dissolving impurities from iron-bearing materials.

Various embodiments may include acidic leaching techniques for dissolving impurities from iron-bearing materials.

Various embodiments for purifying iron-bearing materials may include using a flux, such as NaBO₂, LiBO₂, Li₂B₂O₇, etc.

Various embodiments may include silica dissolution with ammonium bifluoride (NH₄HF₂) techniques for dissolving impurities from iron-bearing materials.

Ammonium fluoride (NH₄F) or ammonium bifluoride (NH₄HF₂) or acid ammonium fluoride (3NH₄·HF₂), or mixtures, solutions, and derivatives thereof, hereafter collectively referred to as AF, may be used to selectively dissolve silicates from iron-bearing ores and minerals, iron, and their partially processed intermediates. Without being bound by any particular scientific interpretation, the inventors believe that AF is able to dissolve or partially dissolve solid siliceous compounds. Compared to other chemical reagents that may dissolve silicates in the target iron-bearing materials such as hydrofluoric acid (HF), alkali metal hydroxides (including NaOH and KOH), and high temperature melts (for example, molten chlorides or fluorides or oxides), AF has the advantage of lower toxicity and greater safety than HF, and greater reactivity at lower temperatures and lower concentrations than the alkali metal hydroxides or high temperature melts.

Various embodiments may include modifying a species of impurity in an iron-bearing material to be a benign compound.

Various embodiments may include process for purifying and/or preparing iron-bearing materials performed at one or more stages in processing iron ore for one or more purposes, such as for processing iron ore into sponge iron based battery components. In various embodiments, the one or more stages in processing iron ore may include prior to, during, and/or after milling, blending, adding binders, adding fluxes, filtration, pelletizing, induration, forming iron ore pellets (IOPs), reduction, crushing, pulverizing, heating, hot pressing, and/or forming a battery component, such as an electrode.

Various embodiments may include methods for preventing or limiting stannate precipitation, such as methods for preventing or limiting stannate precipitation for long-life, high performance iron electrodes. Various embodiments may provide methods for removing CaO and/or MgO from iron electrode materials.

### DESCRIPTION OF THE DRAWINGS

The accompanying drawings, which are incorporated herein and constitute part of this specification, illustrate example embodiments of the claims, and together with the general description given above and the detailed description given below, serve to explain the features of the claims.

FIG. 1A is a schematic of an electrochemical cell, according to various embodiments of the present disclosure.

FIG. 1B illustrates example steps in example battery component production processes in accordance with various embodiments.

FIG. 2A shows graphs of corrosion rates and corrosion intensities of iron in the presence of agitated aqueous solutions.

FIG. 2B shows graphs of results of silica dissolution experiments at different pHs.

FIG. 3 is a graph of pH dependence of silica dissolution experiments.

FIG. 4 is a block diagram illustrating processing operations and devices for processing iron ore into battery components, such as electrodes, and opportunities for impurity removal, such as silica removal, along the iron ore process in accordance with various embodiments.

FIGS. 5-11 illustrate example processes for removing impurities, such as silica, alumina, calcia, magnesia, and/or manganese oxides, from iron-bearing materials in accordance with various embodiments.

FIGS. 12A-12C are Pourbaix diagrams illustrating the range of pHs over which Ca and Mg based aqueous solutions begin to have high solubility of Ca and Mg and comparison to that of Fe.

FIGS. 13-21 illustrate various example systems in which one or more aspects of the various embodiments may be used as part of bulk energy storage systems.

### DETAILED DESCRIPTION

The following examples are provided to illustrate various embodiments of the present systems and methods of the present inventions. These examples are for illustrative purposes, may be prophetic, and should not be viewed as limiting, and do not otherwise limit the scope of the present inventions.

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention. Unless otherwise noted, the accompanying drawings are not drawn to scale.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Generally, the term “about” and the symbol “˜” as used herein unless specified otherwise is meant to encompass a variance or range of ±10%, the experimental or instrument error associated with obtaining the stated value, and preferably the larger of these.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories may not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the teaching of this Specification. Thus, the scope of protection afforded the present inventions should not be limited to a particular embodiment, configuration or arrangement that is set forth in a particular embodiment, example, or in an embodiment in a particular figure.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal resistive elements in series. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electric current and ionic current flowing in the opposite direction as that of a discharging battery in service.

Embodiments of the present invention include apparatus, systems, and methods for long-duration, and ultra-long-duration, low-cost, energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage cells may refer to electrochemical cells that may be configured to store energy over time spans of days, weeks, or seasons. For example, the electrochemical cells may be configured to store energy generated by solar cells during the summer months, when the sunshine is plentiful and solar power generation exceeds power grid requirements, and discharge the stored energy during the winter months, when the sunshine may be insufficient to satisfy power grid requirements.

In general, in an embodiment, the long duration energy storage cell can be a long duration electrochemical cell. In general, this long duration electrochemical cell can store electricity generated from an electrical generation system, when: (i) the power source or fuel for that generation is available, abundant, inexpensive, and combinations and variations of these; (ii) when the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. This electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

According to other embodiments, the present invention includes apparatus, systems, and methods for energy storage at shorter durations of less than about 8 hours. For example, the electrochemical cells may be configured to store energy generated by solar cells during the diurnal cycle, where the solar power generation in the middle of the day may exceed power grid requirements, and discharge the stored energy during the evening hours, when the sunshine may be insufficient to satisfy power grid requirements. As another example, said invention may include energy storage used as backup power when the electricity supplied by the power grid is insufficient, for installations including homes, commercial buildings, factories, hospitals, or data centers, where the required discharge duration may vary from a few minutes to several days.

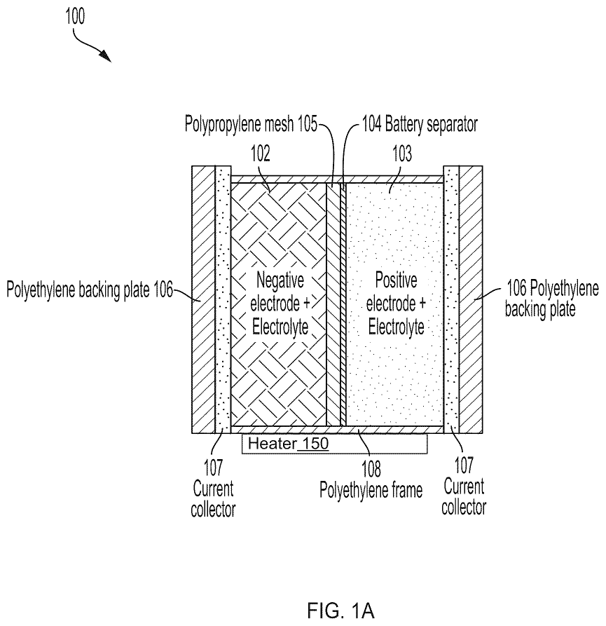

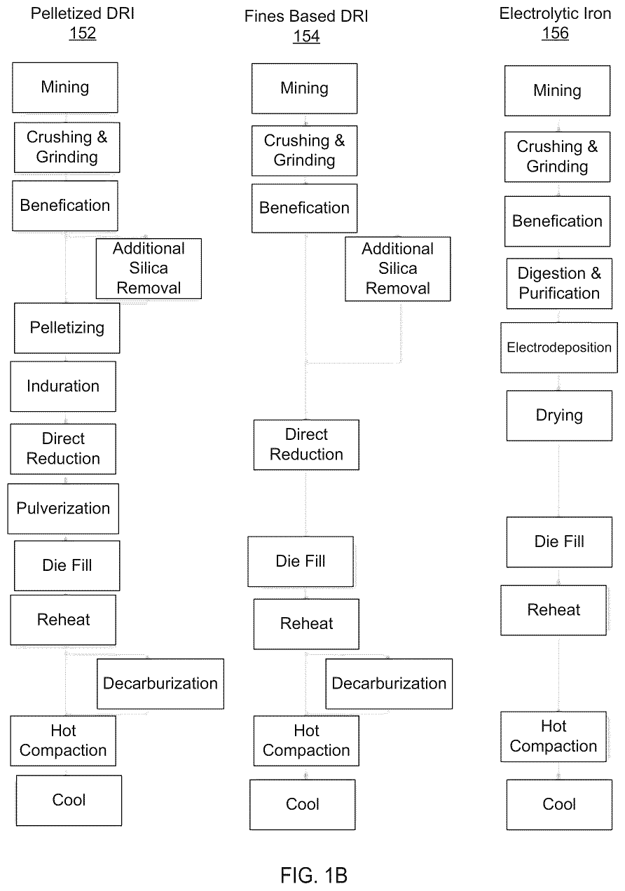

In some embodiments, an electrochemical cell includes a negative electrode, a positive electrode, an electrolyte, and a separator disposed between the positive electrode and the negative electrode (for example as shown in FIG. 1A). FIG. 1A illustrates an example electrochemical cell 100, such as a battery, including a negative electrode and electrolyte 102 separated from a positive electrode and electrolyte 103 by a separator 104. The separator 104 may be supported by a polypropylene mesh 105 and a polyethylene frame 108 of the cell 100. Current collectors 107 may be associated with respective ones of the negative electrode 102 and positive electrode 103 and supported by polyethylene backing plates 106. In some embodiments, the temperature of the electrochemical cell 100, may be controlled, such as by insulation around the cell 100 and/or a heater 150. For example, the heater 150 may raise the temperature of the cell 100 and/or specific components of the cell, such as the electrolyte 102, 103. The configuration of the electrochemical cell 100 in FIG. 1A is merely an example of one electrochemical cell configuration according to various embodiments and is not intended to be limiting. Other configurations, such as electrochemical cells with different type meshes and/or without the polypropylene mesh 105, electrochemical cells with different type frames and/or without the polyethylene frame 108, electrochemical cells with different type current collectors and/or without the current collectors, electrochemical cells with different type backing plates and/or without the polyethylene backing plates 106, electrochemical cells with different type insulation and/or without insulation, and/or electrochemical cells with different type heaters and/or without a heater 150, may be substituted for the example configuration of the electrochemical cell 100 shown in FIG. 1A and other configurations are in accordance with the various embodiments.

In some embodiments, a plurality of electrochemical cells 100 in FIG. 1A may be connected electrically in series to form a stack. In certain other embodiments, a plurality of electrochemical cells 100 may be connected electrically in parallel. In certain other embodiments, the electrochemical cells 100 are connected in a mixed series-parallel electrical configuration to achieve a favorable combination of delivered current and voltage.

According to various embodiments, the negative electrode is comprised of pelletized, briquetted, pressed or sintered iron-bearing compounds. Such iron-bearing compounds may comprise one or more forms of iron, ranging from highly reduced (more metallic) iron to highly oxidized (more ionic) iron. In various embodiments, the iron-bearing compounds may include various iron phases, such as iron oxides, hydroxides, sulfides, carbides, or combinations thereof. In various embodiments, said negative electrode may be sintered iron agglomerates with various shapes. In some embodiments, atomized or sponge iron powders can be used as the feedstock material for forming sintered iron electrodes. In some embodiments, the green body may further contain a binder such as a polymer or inorganic clay-like material. In various embodiments, sintered iron agglomerates may be formed in a furnace, such as a continuous feed calcining furnace, batch feed calcining furnace, shaft furnace, rotary calciner, rotary hearth, etc. In other embodiments, iron ore may be fed directly into a reduction furnace without thermal treatment (as in e.g., various sponge iron making processes or fluidized bed reactors). In various embodiments, iron active material feedstocks may comprise forms of reduced and/or sintered iron-bearing precursors known to those skilled in the art as direct reduced iron (DRI), and/or its byproduct materials. Various embodiments may include processing iron active material feedstocks, such as DRI pellets, using electrical, electrochemical, mechanical, chemical, and/or thermal processes before introducing the iron active material feedstocks into the electrochemical cell.

Various embodiments are discussed in relation to the use of iron active material feedstocks, such as direct reduced iron (DRI)(also referred to as sponge iron), as a material of a battery (or cell), as a component of a battery (or cell) and combinations and variations of these. In various embodiments, the iron active material feedstock (e.g., DRI) may be produced from, or may be, material which is obtained from the reduction of natural or processed iron ores, without reaching the melting temperature of iron. In various embodiments the iron ore may be taconite or magnetite or hematite or goethite, etc. In various embodiments, the iron active material feedstock (e.g., DRI) may be in the form of pellets, which may be spherical or substantially spherical. In various embodiments, the iron active material feedstock (e.g., DRI) may be in forms other than pellets, such as fines, granules, briquettes, chips, disks, lumps, powders, dusts, etc., that may be other than spherical. In various embodiments the iron active material feedstock (e.g., DRI) may be porous, containing open and/or closed internal porosity. In various embodiments the iron active material feedstock (e.g., DRI) may comprise materials that have been further processed by hot or cold briquetting. In various embodiments, the iron active material feedstock (e.g., DRI) may be produced by reducing iron ore form factors (e.g., iron ore pellets, briquettes, etc.) to form a more metallic (more reduced, less highly oxidized) material, such as iron metal (Fe⁰), wustite (FeO), or a composite form (e.g., composite pellet, composite briquette, etc.) comprising iron metal and residual oxide phases. In various non-limiting embodiments, the iron active material feedstock (e.g., DRI) may be reduced iron ore taconite, direct reduced (“DR”) taconite, reduced “Blast Furnace (BF) Grade” pellets, reduced “Electric Arc Furnace (EAF)-Grade” pellets, “Cold Direct Reduced Iron (CDRI)” pellets, direct reduced iron (“DRI”) pellets, Hot Briquetted Iron (HBI), or any combination thereof. In the iron and steelmaking industry, DRI is sometimes referred to as “sponge iron;” this usage is particularly common in India or in the press and sinter powder metallurgy industry.

According to various embodiments, an electrochemical cell, such as cell 100 of FIG. 1A, includes a negative electrode (also referred to as an anode), a positive electrode (also referred to as a cathode), and an electrolyte. The negative electrode may be an iron material. The electrolyte may be an aqueous solution. In certain embodiments the electrolyte may be an alkaline solution (pH>10). In certain embodiments, the electrolyte may be a near-neutral solution (10>pH>4).

Various embodiments include processes for purifying iron-bearing materials. Various embodiments include purification of iron ores, iron, and their intermediates. Various embodiments include processes for preparing iron-bearing materials. Various embodiments include preparation of iron ores, iron, and their intermediates. Various embodiments may include processes for purifying and/or preparing iron-bearing materials for various purposes, such as for use in battery applications or any other purpose.

Various embodiments include processes for removing impurities, such as silica, alumina, calcia, magnesia, and/or manganese oxides, from iron-bearing materials.

Various embodiments may include processes for purifying iron-bearing materials, such as by removing impurities including silica, alumina, CaO, and/or MgOa, that may occur at one or more steps in processes of forming any type of iron-bearing materials, such as one or more steps in the production of DRI pellets, one or more steps in the production of DRI fines, one or more steps in an electrolytic iron production process, etc. Various embodiments may include processes for purifying iron-bearing materials, such as by removing impurities including silica, alumina, calcia, magnesia, and/or manganese oxides, that may occur at one or more steps in processes of forming any type of iron-bearing materials for use in batteries, such as processes for using pelletized DRI for making an electrode or other battery component, processes for using DRI fines for making an electrode or other battery component, process for using electrolytic iron for making an electrode or other battery component, etc. As examples, FIG. 1B illustrates example steps in a battery component production process 152 using pelletized DRI, example steps in a battery component production process using fines-based DRI 154, and example steps in a battery component production process using electrolytic iron 156. The steps in processes 152-156 are merely examples, and various embodiments may include other processes and/or other steps.

As examples, processes 152-156 may start with a mining step in which iron is mined and rock or other materials associated with an iron ore deposit is extracted. In various embodiments, embodiment methods as discussed herein to purify iron-bearing materials, such as by removing impurities including silica, alumina, calcia, magnesia, and/or manganese oxides, may be performed during and/or after mining in processes 152-156. In processes 152-156, a crushing and grinding step may follow mining in which the mined rock is crushed and/or ground into smaller pieces. Crushing and grinding may reduce the mined rock in smaller pieces than were originally mined and may begin to separate desired iron ore from gangue materials in the mined rock. In various embodiments, embodiment methods as discussed herein to purify iron-bearing materials, such as by removing impurities including silica, alumina, calcia, magnesia, and/or manganese oxides, may be performed prior to, during, and/or after crushing and grinding steps in processes 152-156. In processes 152-156, beneficiation may follow crushing and grinding and may include chemical and/or physical separation of gangue materials from iron ore. In various embodiments, embodiment methods as discussed herein to purify iron-bearing materials, such as by removing impurities including silica, alumina, calcia, magnesia, and/or manganese oxides, may be performed prior to, during, and/or after beneficiation in processes 152-156. Crushing and grinding and/or beneficiation steps may result in ore concentrates. In processes 152 and 154, optional silica removal steps may occur after beneficiation. For example, silica removal steps may remove silica and/or other materials from ore concentrates. In various embodiments, embodiment methods as discussed herein to purify iron-bearing materials, such as by removing impurities including silica, alumina, calcia, magnesia, and/or manganese oxides, may be performed prior to, during, and/or after optional silica removal steps in processes 152 and 154. In process 152, a pelletizing step may occur after beneficiation and/or optional silica removal steps. In various embodiments, embodiment methods as discussed herein to purify iron-bearing materials, such as by removing impurities including silica, alumina, calcia, magnesia, and/or manganese oxides, may be performed prior to, during, and/or after the pelletizing step in process 152. In process 152, an induration (or sintering) step may follow pelletizing. In various embodiments, embodiment methods as discussed herein to purify iron-bearing materials, such as by removing impurities including silica, alumina, calcia, magnesia, and/or manganese oxides, may be performed prior to, during, and/or after the induration step in process 152. In processes 152 and 154 a direct reduction step may occur (e.g., after induration in process 152 or after optional silica removal in process 154) in which iron ores may be reduced by heating without reaching the melting temperature of iron. In various embodiments, embodiment methods as discussed herein to purify iron-bearing materials, such as by removing impurities including silica, alumina, calcia, magnesia, and/or manganese oxides, may be performed prior to, during, and/or after a direct reduction step in processes 152 and 154. In process 152, the resulting DRI pellets may be pulverized to reduce their size and/or to create DRI fines. In various embodiments, embodiment methods as discussed herein to purify iron-bearing materials, such as by removing impurities including silica, alumina, calcia, magnesia, and/or manganese oxides, may be performed prior to, during, and/or after the pulverization step in process 152. In process 156, after beneficiation, digestion and purification of the iron ore may be performed followed by electrodeposition and drying. In various embodiments, embodiment methods as discussed herein to purify iron-bearing materials, such as by removing impurities including silica, alumina, calcia, magnesia, and/or manganese oxides, may be performed prior to, during, and/or after digestions and purification in processes 156. In various embodiments, embodiment methods as discussed herein to purify iron-bearing materials, such as by removing impurities including silica, alumina, calcia, magnesia, and/or manganese oxides, may be performed prior to, during, and/or after electrodeposition in processes 156. In various embodiments, embodiment methods as discussed herein to purify iron-bearing materials, such as by removing impurities including silica, alumina, calcia, magnesia, and/or manganese oxides, may be performed prior to, during, and/or after drying in processes 156. The iron material resulting from pulverization in process 152, direct reduction in process 154, and/or drying in process 156 may be placed in a die in processes 152-156 and heated. In various embodiments, embodiment methods as discussed herein to purify iron-bearing materials, such as by removing impurities including silica, alumina, calcia, magnesia, and/or manganese oxides, may be performed prior to, during, and/or after filling the die in processes 152-156. In various embodiments, embodiment methods as discussed herein to purify iron-bearing materials, such as by removing impurities including silica, alumina, calcia, magnesia, and/or manganese oxides, may be performed prior to, during, and/or after reheating in processes 152-156. In processes 152 and 154 an optional decarburization step may occur after reheating the filled die. In various embodiments, embodiment methods as discussed herein to purify iron-bearing materials, such as by removing impurities including silica, alumina, calcia, magnesia, and/or manganese oxides, may be performed prior to, during, and/or after decarburization in processes 152 and 154. In processes 152-156 the iron material in the die may be hot compacted and then cooled resulting in the formation of a battery component, such as an iron electrode. In various embodiments, embodiment methods as discussed herein to purify iron-bearing materials, such as by removing impurities including silica, alumina, calcia, magnesia, and/or manganese oxides, may be performed prior to, during, and/or after hot compaction in processes 152-156. In various embodiments, embodiment methods as discussed herein to purify iron-bearing materials, such as by removing impurities including silica, alumina, calcia, magnesia, and/or manganese oxides, may be performed prior to, during, and/or after cooling in processes 152-156.

Various embodiments may provide processes for purifying iron-bearing materials at one or more different steps, such as when iron is at an ore concentrate step (e.g., after obtaining (e.g., mining) of the iron ore and after grinding and beneficiation of the iron ore), when the iron is at an iron ore pellet step, when the iron is at a high purity iron ore fines or iron ore pellet fragments (e.g., less than 6 mm) step, when the iron is at a direct reduced iron step, when the iron is part of a completed anode, before and/or after the addition of a binder, etc. Table 1 lists various example steps/iron-bearing materials and considerations for each.

TABLE 1

| Step | Pro's | Con's |
|---|---|---|
| As ore concentrate (after | 1. Likely lowest cost | 1. For commercial |
| grinding + beneficiation) | 2. Highest flexibility - | implementation, highest |
| | working with fine powders. | volume of material needed |
| | Easy to leach, etc. Can do | at this intervention stage. |
| | both physical and chemical | Material needs to be added |
| | processing. | until pelletizing plant is at |
| | 3. Fastest mass transport of | new steady state. IOP then |
| | the leached materials the | needs to be run in trial |
| | particles because they are | reduction processes. |
| | finely-ground powders | 2. Logistically most |
| | 4. Furthest upstream | complex as custom material |
| | | must be introduced and |
| | | tracked through all |
| | | downstream processes. |
| As Iron Ore Pellets | 1. Iron oxides are not | 1. Large size of pellets may |
| | affected by alkaline | inhibit kinetics of transport- |
| | leaching, so alkaline | limited processes. |
| | leaching is high selectivity | 2. Limited to chemical |
| | and process windows are | processing (not physical |
| | wide. | processing like |
| | 2. Advantage of post | grinding + beneficiation) |
| | induration is that all of the | |
| | iron oxide is hematite, | |
| | regardless of whether the | |
| | iron oxide started as | |
| | magnetite or hematite. | |
| As high purity iron ore fines | 1. Iron oxides are not | 1. Not compatible with a |
| or iron ore pellet fragments | affected by alkaline | wide range of reduction |
| (<6 mm) | leaching, so alkaline | processes (especially shaft |
| | leaching is high selectivity | furnace direct reduction) |
| | and process windows are | without further size |
| | wide. | adjustments (e.g. grinding or |
| | 2. Smaller particles lessen | agglomeration). |
| | transport length scales. | |
| As Direct Reduced Iron | 1. Intervening at later stages | 1. Metallic iron is much |
| | in supply chain often means | less chemically robust than |
| | simpler logistics. | iron oxides - it is unstable in |
| | 2. Another advantage is | both alkaline and acidic |
| | yield as less iron material is | leaching processes. There is |
| | being processed due to yield | a narrower window of |
| | losses at previous steps. | processes and process |
| | | windows for DRI |
| | | purification. |
| | | 2. Processing at DRI stage |
| | | could introduce unwanted |
| | | impurities or oxidation in |
| | | the DRI, interfering with hot |
| | | compaction - washing is |
| | | needed for most leaching |
| | | chemistries |
| | | 3. Limited to chemical |
| | | processing. |
| | | 4. Additionally, the iron |
| | | present in DRI is as metallic |
| | | iron, Fe₃C and FeO. |
| As a completed anode | 1. Potentially simplest | 1. Most risk for product |
| | logistically. | performance if chemicals |
| | 2. Leaching after high | are introduced that are |
| | temperature processing | detrimental for performance. |
| | means chemical interactions | 2. Limited to chemical |
| | with high temperature | processing. |
| | processing are avoided | |
| | (potentially less stringent | |
| | washing conditions, | |
| | especially for alkaline | |
| | leaching where the leachant | |
| | chemistry would be | |
| | compatible in small amounts | |
| | with electrolyte chemistry) | |

Various embodiments may provide processes for purifying iron-bearing materials that may produce ore concentrates with selected soluble silica content ranges. The soluble silica content may be defined as the silica content that is soluble in an alkaline environment once the material has been incorporated into an alkaline battery. The soluble silica specifications are essentially the same for iron ore pellets and the iron ore concentrate because the silica specification is given on a per-wt %-Fe basis, and the amount of silica. The soluble silica content may be measured by processing the material with extended leaching (>2 weeks) of the materials at high temperatures close to the boiling point of the alkaline leaching solution (>90° C.). Following the leaching treatment, the soluble silica may be measured by one of two measurement techniques, either: 1) Subsequent analysis of the amount of Si left in the material via techniques known in the art for quantifying the mass fraction of silica including e.g., inductively coupled plasma coupled with suitable spectroscopy technique. If defining the silicon content relative to the amount of Fe left in material, the material may be assayed of the total iron content via techniques known in the art for quantifying total iron content such as ISO 2597, and comparison of the Si and Fe contents in the material from before and after the leaching operation; or 2) Direct measurement of the silicon leached into the alkaline leaching solution in the form of silicates. The mass fraction of dissolved silicates may be measured by any of the techniques known in the art for detecting silicates in alkaline solution including but not limited to ICP-OES. The alkaline leaching solution may be a solution of 7M KOH. In the case where the silica is significantly different in solubility in the electrolyte to be used in the electrochemical cells where Fe active material is to be used, the soluble silica leaching procedure may instead be performed in the electrolyte to be used in the electrochemical cells. The inventors have found through experiment that >2 weeks at 90° C. is often sufficient to measure the soluble silica content of an Fe active material. However, in some instances, silica may be very slow to dissolve from the Fe active materials, and a longer time or different dissolution temperature may be needed to achieve full dissolution of the silica. In some instances, the Fe active material may need to be electrochemically cycled to release all of the silica. In these cases where the Fe active material may need to be electrochemically cycled to release all of the silica, the soluble silica content may be measured by sampling the electrolyte and/or Fe active material harvested from cycled electrochemical cells. Various embodiments may provide processes for purifying iron-bearing materials that may produce ore concentrates with selected soluble silica content ranges where the soluble silica content specified range is the weight percent (wt %) SiO₂ relative to wt % Fe, such as 0<0.01 x<0.85, 0<0.01 x<0.65, 0<0.01 x<0.33, 0<0.01 x<0.16, 0<0.01 x<0.11, etc.

The amount of soluble silica permissible in the cell may instead, or additionally, be defined based on the amount of silica that enters the electrolyte. The dissolved silica may be measured by sampling the electrolyte from the cell, or performing a leaching experiment out of the cell as-described above, and converting the silica content to an equivalent silica concentration that would be measured in the cell through suitable adjustment of the leaching Fe active material ratio (in e.g. mL leachant/g Fe active) relative to the electrolyte to Fe active material ratio (in e.g. mL electrolyte/g Fe active). The soluble silica content should be <400 mM silicates, <200 mM silicates, <100 mM silicates, <50 mM silicates, <25 mM silicates, <10 mM silicates, and most preferably <5 mM silicates.

Various embodiments may provide processes for purifying iron-bearing materials that may produce iron ore pellets (IOPs) with selected soluble silica content ranges. Many other metrics may be collected related to the ability to process, transport, and reduce the iron oxide pellets in various reduction technologies. The IOP material properties listed here are simply examples of those that may be critical for performance of secondary storage systems. The IOP may be otherwise engineered to allow proper processing of the IOP in downstream steps (e.g., reduction). The strength, other impurity levels, etc. are all relevant for processing success, but also specific to the details of the processing conducted. Within-pellet open porosity is specifically the open porosity. The open porosity may be measured by measuring the envelope density of the pellet and the skeletal density of the pellet, thereby deriving the porosity within the pellet. This may be measured by various techniques known in the art for measuring the porosity of porous bodies, including helium pycnometry or mercury porosimetry for true densities, and immersion density or helium pycnometry for envelope densities. Various embodiments may provide processes for purifying iron-bearing materials that may produce iron ore pellets (IOPs) with selected soluble silica content ranges where the soluble silica content specified range is the weight percent (wt %) SiO₂ relative to wt % Fe, such as 0<0.01 x<0.85, 0<0.01 x<0.65, 0<0.01 x<0.33, 0<0.01 x<0.16, 0<0.01 x<0.11, etc. Various embodiments may provide processes for purifying iron-bearing materials that may produce iron ore pellets (IOPs) with selected within-pellet open porosity ranges, such as 20-50 volume percent (vol. %), 25-45 vol. %, 29-42 vol. %, less than 50 vol. %, greater than 20 vol. %, etc. Various embodiments may provide processes for purifying iron-bearing materials that may produce iron ore pellets (IOPs) with selected total iron content, such as greater than 62%, greater than 65%, greater than 67%, etc.

Various embodiments may provide processes for purifying iron-bearing materials that may produce DRI (or similar sponge iron) with selected soluble silica content ranges. Many other metrics may be collected related to the to the ability to process, transport, and reduce the DRI in various reduction technologies. The DRI material properties listed here are simply examples of those that may be critical for performance of secondary storage systems. The DRI may be otherwise engineered to allow proper processing of the DRI in downstream steps or incorporation into a battery. The strength, other impurity levels, etc. may all be relevant for processing success and incorporation into a battery, but also specific to the details of the processing conducted. Within-DRI pellet open porosity is specifically the open porosity. The open porosity may be measured by measuring the envelope density of the DRI pellet and the skeletal density of the DRI pellet, thereby deriving the porosity within the DRI pellet. This may be measured by various techniques known in the art for measuring the porosity of porous bodies, including helium pycnometry or mercury porosimetry for true densities, and immersion density or helium pycnometry for envelope densities. Various embodiments may provide processes for purifying iron-bearing materials that may produce DRI (or similar sponge iron), such as DRI pellets, with selected soluble silica content ranges where the soluble silica content specified range is the weight percent (wt %) SiO₂ relative to wt % Fe, such as 0<0.01 x<0.85, 0<0.01 x<0.65, 0<0.01 x<0.33, 0<0.01 x<0.16, 0<0.01 x<0.11, etc. Various embodiments may provide processes for purifying iron-bearing materials that may produce DRI (or similar sponge iron), such as DRI pellets, with selected within-DRI pellet open porosity ranges, such as 50-75 volume percent (vol. %), 55-72 vol. %, 57-67 vol. %, less than 75 vol. %, greater than 50 vol. %, etc. Various embodiments may provide processes for purifying iron-bearing materials that may produce DRI (or similar sponge iron), such as DRI pellets, with selected total iron content, such as greater than 85%, greater than 90%, greater than 92%, etc.

Various embodiments may provide processes for purifying iron-bearing materials that may produce high purity iron ore fines or iron ore pellet (IOP) fragments (e.g., less than 6 mm) with selected soluble silica content ranges. For some iron ores, the within-ore porosity need not be high or specified. The mineralogy of the ore permits the ore to be reduced to a highly-metallized state with a high amount of measurable porosity preceding the reduction process. Within-pellet open porosity for IOP fragments is specifically the open porosity. The open porosity may be measured by measuring the envelope density of the IOP fragments and the skeletal density of the IOP fragment, thereby deriving the porosity within the IOP fragment. This may be measured by various techniques known in the art for measuring the porosity of porous bodies, including helium pycnometry or mercury porosimetry for true densities, and immersion density or helium pycnometry for envelope densities. Various embodiments may provide processes for purifying iron-bearing materials that may produce high purity iron ore fines or iron ore pellet (IOP) fragments (e.g., less than 6 mm) with selected soluble silica content ranges where the soluble silica content specified range is the weight percent (wt %) SiO₂ relative to wt % Fe, such as 0<0.01 x<0.85, 0<0.01 x<0.65, 0<0.01 x<0.33, 0<0.01 x<0.16, 0<0.01 x<0.11, etc. Various embodiments may provide processes for purifying iron-bearing materials that may produce high purity iron ore fines or iron ore pellet (IOP) fragments (e.g., less than 6 mm) with selected within-pellet open porosity (for IOP fragments) ranges, such as 20-50 volume percent (vol. %), 24-45 vol. %, 29-42 vol. %, less than 50 vol. %, greater than 20 vol. %, etc. Various embodiments may provide processes for purifying iron-bearing materials that may produce high purity iron ore fines or iron ore pellet (IOP) fragments (e.g., less than 6 mm) with selected total iron content, such as greater than 62%, greater than 65%, greater than 67%, etc.

Various embodiments may provide processes for purifying iron-bearing materials that may produce material that has been fabricated into an electrode for use in an electrochemical system with selected soluble silica content ranges. The geometric density of the active material containing region of the electrode may be defined as the mass of the electrode active materials relative to the volume occupied by the active materials, inclusive of the porosity within and between the active material particles. The electrode geometric density should exclude the weight and volume of the current collector or other portions of the electrode design which do not contain the active materials. Various embodiments may provide processes for purifying iron-bearing materials that may produce material that has been fabricated into an electrode for use in an electrochemical system with selected soluble silica content ranges where the soluble silica content specified range is the weight percent (wt %) SiO₂ relative to wt % Fe, such as 0<0.01 x<0.85, 0<0.01 x<0.65, 0<0.01 x<0.33, 0<0.01 x<0.16, 0<0.01 x<0.11, etc. Various embodiments may provide processes for purifying iron-bearing materials that may produce material that has been fabricated into an electrode for use in an electrochemical system with selected geometric density of actives region of electrode ranges, such as 1.2-4 grams per cubic centimeter (g/cc), 1.5-4 g/cc, 1.8-2.6 g/cc, 1.9-2.5 g/cc, less than 4 g/cc, greater than 1.2 g/cc, etc. Various embodiments may provide processes for purifying iron-bearing materials that may produce material that has been fabricated into an electrode for use in an electrochemical system with selected total iron content of iron based actives, such as greater than 85%, greater than 90%, greater than 92%, etc.

Various embodiments for purifying iron-bearing materials may include leaching processes. A leaching process may be considered any process in which 1) a material is exposed to a leaching solution and 2) a component of the material exposed to the leaching solution is partially or fully dissolved into the leaching solution. In the context of this disclosure, etching and leaching may be considered synonymous. Said another way, instances in this disclosure of the term “etching” or “etch” in relation to a process may be considered synonyms for the term “leaching” or “leach” in relation to that process and such process should be understood as a “leaching processes” as defined in this paragraph.

Various embodiments for purifying iron-bearing materials may include alkaline leaching processes. Various embodiments include processes for purifying iron-bearing materials comprising leaching one or more soluble species of impurities out of iron-bearing materials using a leaching solution comprising fluorine.

Various embodiments may include one or more processes for leaching soluble species out of iron-based materials. Various embodiments may include alkaline leaching techniques for dissolving impurities from iron-bearing materials. Dissolution-based processes are attractive as they can purify the iron-bearing materials to very low concentrations of impurities.

In some alkaline leaching processes, a concentrated base (e.g., NaOH and/or KOH) may be used to leach base-soluble species out of an iron-bearing material. Higher concentrations of base are known to accelerate the leaching kinetics of silica and alumina. Concentrations of 0.1 to 10 M may be industrially-relevant leaching solutions. In various embodiments, the fluorine containing component of the leaching solution may have a molar concentration of about, or above, 100 parts per million (ppm), such as about 100 ppm, between 100 and 10000 ppm, about 100-500 ppm, about 500 ppm, between 100 ppm and 5000 ppm, between about 500 ppm and 5000 ppm, above 500 ppm, 500-5000 ppm, about 5000 ppm, above 5000 ppm, between about 5000 ppm and 10000 ppm, about 10000 ppm, etc. In various embodiments, the fluorine containing component of the leaching solution has a molar concentration between 500 and 5000 ppm.

In some processes, the leaching solution is washed and re-concentrated in order to recover the expensive leaching chemicals in the leaching solution. In such processes, that leaching solution's concentration may be selected so that the concentration of the re-concentrated leaching solution is similar to or the same as the leaching bath, such that the leaching may proceed in a closed loop with limited-to-no need to refresh the solution's composition.

In general, the leaching process may utilize the leaching solution more effectively if the primary leached impurities are removed from the leaching solution such that the leaching solution does not get saturated with the dissolved impurities. In some leaching processes, an impurity-removing chemical may be added to the leaching solution to keep the solution from becoming saturated. Two of the main impurities of interest for removal from iron-bearing materials are silica and alumina. Dissolved silica and alumina may be effectively scrubbed from alkaline solutions by calcium hydroxide or related chemicals such as calcium oxide (which can convert to calcium oxide when hydrated). Thus, in some leaching processes, the leaching solution may be in contact with a calcium hydroxide-containing material so that the silica and alumina do not saturate the solution. In some leaching processes, the calcium hydroxide-containing material (or a related precursor) may be continuously added and removed to enable a continuous leaching process to be performed without saturating the bath.

In some leaching processes, the bath may be heated to accelerate the dissolution of silica and alumina such that the materials leach on a practically-reasonable and cost-effective timescale. The temperature of the bath needed is a function of the ore microstructure and phase of the silica- and alumina-containing impurities, but in general, temperatures between 30° C. and the boiling point of the leaching solution are preferred temperatures.

In some leaching processes, the removal of the dissolved impurities may be more efficient at a different temperature from the temperature that is best for leaching the impurities from the iron-containing materials. In such circumstances, the different processes may take place at separate temperatures. For example, silicate-based species may be dissolved in alkaline solution at high temperatures, and precipitated from the solution at low temperatures via a calcium or magnesium hydroxide material.

The solubility and dissolution rate of silica-based species in alkali is a strong function of the phase of the silica. In some leaching process, the iron-bearing material may be selected such that the silica-based species is a fast-dissolving one. In some embodiments, ores or other sources of iron containing faster-dissolving species may be used to ease processing and lower costs. For example, a faster-dissolving species such as amorphous silica and/or tridymite/cristobalite may be preferred relative to the slowest-dissolving quartz phase.

If a metallized iron-bearing material is used for the purification process, then the metallic iron may be oxidized during the etching process. This is generally not desirable, and so a corrosion inhibitor may be introduced into the feed material and/or leaching solution to slow the oxidation of the iron while the impurity removal takes place. In one aspect, sulfides or silicates may be introduced into the solution to slow the corrosion of the metallic iron. In some embodiments, corrosion inhibitors used in the field of ferrous metallurgy to inhibit aqueous corrosion may be used to slow the corrosion of the metallic iron. Example corrosion inhibitors that may be introduced into the feed material and/or leaching solution in various embodiments may be selected from the non-limiting set of sodium thiosulfate, sodium thiocyanate, polyethylene glycol (PEG) 1000, trimethylsulfoxonium iodide, zincate (by dissolving ZnO in NaOH), hexanethiol, decanethiol, sodium chloride, sodium permanganate, lead (IV) oxide, lead (II) oxide, magnesium oxide, sodium chlorate, sodium nitrate, sodium acetate, iron phosphate, phosphoric acid, sodium phosphate, ammonium sulfate, ammonium thiosulfate, lithopone, magnesium sulfate, iron(III) acetylacetonate, hydroquinone monomethyl ether, sodium metavanadate, sodium chromate, glutaric acid, dimethyl phthalate, methyl methacrylate, methyl pentynol, adipic acid, allyl urea, citric acid, thiomalic acid, N-(2-aminoethyl)-3-aminopropyl trimethoxysilane, propylene glycol, trimethoxysilyl propyl diethylene, aminopropyl trimethoxysilane, dimethyl acetylenedicarboxylate (DMAD), 1,3-diethylthiourea, N,N′-diethylthiourea, aminomethyl propanol, methyl butynol, amino modified organosilane, succinic acid, isopropanolamine, phenoxyethanol, dipropylene glycol, benzoic acid, N-(2-aminoethyl)-3-aminopropyl, behenamide, 2-phosphonobutane tricarboxylic, mipa borate, 3-methacryloxypropyltrimethoxysilane, 2-ethylhexoic acid, isobutyl alcohol, t-butylaminoethyl methacrylate, diisopropanolamine, propylene glycol n-propyl ether, sodium benzotriazolate, pentasodium aminotrimethylene phosphonate, sodium cocoyl sarcosinate, laurylpyridinium chloride, steartrimonium chloride, stearalkonium chloride, calcium montanate, quaternium-18 chloride, sodium hexametaphosphate, dicyclohexylamine nitrite, lead stearate, calcium dinonylnaphthalene sulfonate, iron(II) sulfide, sodium bisulfide, pyrite, sodium nitrite, complex alkyl phosphate ester (e.g. RHODAFAC® RA 600 Emulsifier), 4-mercaptobenzioc acid, ethylenediaminetetraacetic acid, ethylenediaminetetraacetate (EDTA), 1,3-propylenediaminetetraacetate (PDTA), nitrilotriacetate (NTA), ethylenediaminedisuccinate (EDDS), diethylenetriaminepentaacetate (DTPA), and other aminopolycarboxylates (APCs), diethylenetriaminepentaacetic acid, 2-methylbenzenethiol, 1-octanethiol, manganese dioxide, manganese (III) oxide, manganese (II) oxide, manganese oxyhydroxide, manganese (II) hydroxide, manganese (III) hydroxide, bismuth sulfide, bismuth oxide, antimony(III) sulfide, antimony(III) oxide, antimony(V) oxide, bismuth selenide, antimony selenide, selenium sulfide, selenium(IV) oxide, propargyl alcohol, 5-hexyn-1-ol, 1-hexyn-3-ol, N-allylthiourea, thiourea, 4-methylcatechol, trans-cinnamaldehyde, Iron(III) sulfide, calcium nitrate, hydroxylamines, benzotriazole, furfurylamine, quinoline, tin(II) chloride, ascorbic acid, 8-hydroxyquinoline, pyrogallol, tetraethylammonium hydroxide, calcium carbonate, magnesium carbonate, antimony dialkylphosphorodithioate, potassium stannate, sodium stannate, tannic acid, gelatin, saponin, agar, 8-hydroxyquinoline, bismuth stannate, potassium gluconate, lithium molybdenum oxide, potassium molybdenum oxide, hydrotreated light petroleum oil, heavy naphthenic petroleum oil (e.g. sold as Rustlick® 631), antimony sulfate, antimony acetate, bismuth acetate, hydrogen-treated heavy naphtha (e.g. sold as WD-40®), tetramethylammonium hydroxide, NaSb tartrate, urea, D-glucose, C₆Na₂O₆, antimony potassium tartrate, hydrazine sulfate, silica gel, triethylamine, potassium antimonate trihydrate, sodium hydroxide, 1,3-di-o-tolyl-2-thiourea, 1,2-diethyl-2-thiourea, 1,2-diisopropyl-2-thiourea, N-phenylthiourea, N,N′-diphenylthiourea, sodium antimonyl L-tartrate, rhodizonic acid disodium salt, sodium selenide, potassium sulfide, and combinations thereof.

In various embodiments, concentrates of different origins, such as fluxes, etc., may be added to the iron-bearing materials to modify the phases of impurities, such as the phases of silica, phases of alumina, phases of silica and alumina, etc., to make the impurities (e.g., silica, alumina, calcia, magnesia, and/or manganese oxides, etc.) easier to dissolve, insoluble, or more easily mechanically separatable. As one example, during the blending stage of the pelletizing process, concentrates of different origins, fluxes, etc., may be added to modify the silica, alumina, calcia, magnesia, and/or manganese oxides phases to make the silica, alumina, calcia, magnesia, and/or manganese oxides easier to dissolve, insoluble, or easier to mechanically separate. As a specific example, dolomitic lime (MgO—CaO) may be added to the concentrate during induration and the silica may combine with the dolomitic lime to make SiO₂—MgO—CaO phase which can be amorphous. In another example, alumina (e.g. in the form of bauxite or other mineral forms of alumina) may be added in combination with CaO or MgO to make a low-melting, amorphous SiO₂—Al₂O₃— (CaO or MgO) phase.

Various embodiments for purifying iron-bearing materials may include acidic leaching.

Various embodiments may include one or more materials and/or processes for leaching soluble species out of iron-based materials. Various embodiments may include acidic leaching techniques for dissolving impurities from iron-bearing materials.

Silica may be dissolved in an acid, for example hydrofluoric acid (HF). However, a first problem may be that a rate of silica dissolution may be difficult to repeat by using HF. A second problem may be iron oxides are unstable in acidic environments; they may dissolve to form soluble Fe-containing ionic species such as Fe2+ in acidic solutions.

In a first embodiment, a first etching rate of the iron oxides is tuned to be much slower than a second etching rate of impurities (silica) that are desired to be dissolved or otherwise removed from the iron-bearing material. In a further example of the first embodiment, for etchants comprising HF, the first etching rate of iron oxides is very slow and the second etching rate of silica is fast.

In a second embodiment, an iron-bearing material is immersed in a buffered hydrofluoric acid solution. A first example of the buffered hydrofluoric acid solution comprises ammonium bifluoride (NH₄HF₂). A second example of the buffered hydrofluoric acid solution comprises potassium bifluoride (KHF₂).

In a third embodiment, an iron-bearing material is immersed in an acid mixture. The acid mixture may comprise HF, hydrochloric acid, sulfuric acid, and nitric acid.

Various embodiments for purifying iron-bearing materials may include leaching soluble species out of the iron-based materials, for example via silica dissolution with ammonium bifluoride (NH₄HF₂). For example, ammonium bifluoride (NH₄HF₂) may be used to dissolve silica-based impurities in iron-bearing materials, more specifically exposure of silica to ammonium fluoride or a mixture of ammonium fluoride and acid ammonium fluoride in an aqueous medium to produce ammonium silicofluoride. The ammonium silicofluoride may be subsequently precipitated to produce precipitated silica and potentially enable recycling of the ammonium bifluoride etchant, thereby enabling a closed-loop etching process through dissolution and precipitation of silica. In addition to ammonium bifluoride and hydrogen fluoride, other etchants may be used to remove silica from iron-bearing materials in various embodiments. For example, such etchants contain fluorine, F. Several such etchants are discussed in Konstantinos D. Demadis et al. 2012, Additive-Driven Dissolution Enhancement of Colloidal Silica. 3. Fluorine-Containing Additives (herein referred to as Demadis et al.), and Ehrlich et al. 2010 Modern Views on Desilicification: Biosilica and Abiotic Silica Dissolution in Natural and Artificial Environments both of which are fully incorporated herein as part of this disclosure for all purposes, and which describe various etchants any of which may be examples of etchants used in various embodiments to dissolve silica-based impurities in iron-bearing materials. Of particular interest are etchants that yield solubilities and high etching rates with minimal safety risks and high selectivity of etching silica, alumina, calcia, magnesia, and/or manganese oxides relative to iron. One such etchant is Sodium Fluorophosphate Na₂PO₃F.

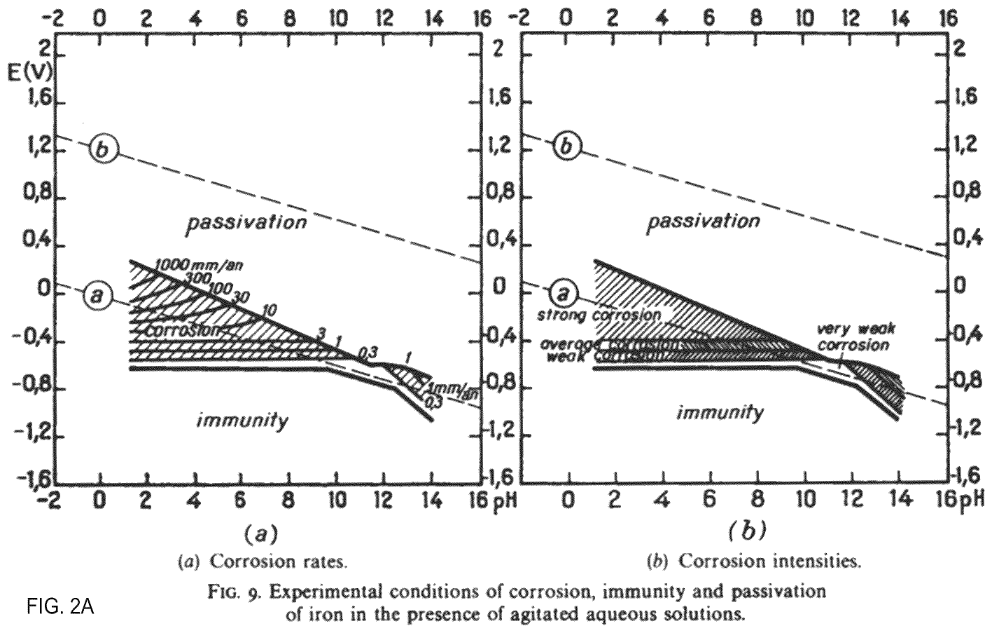

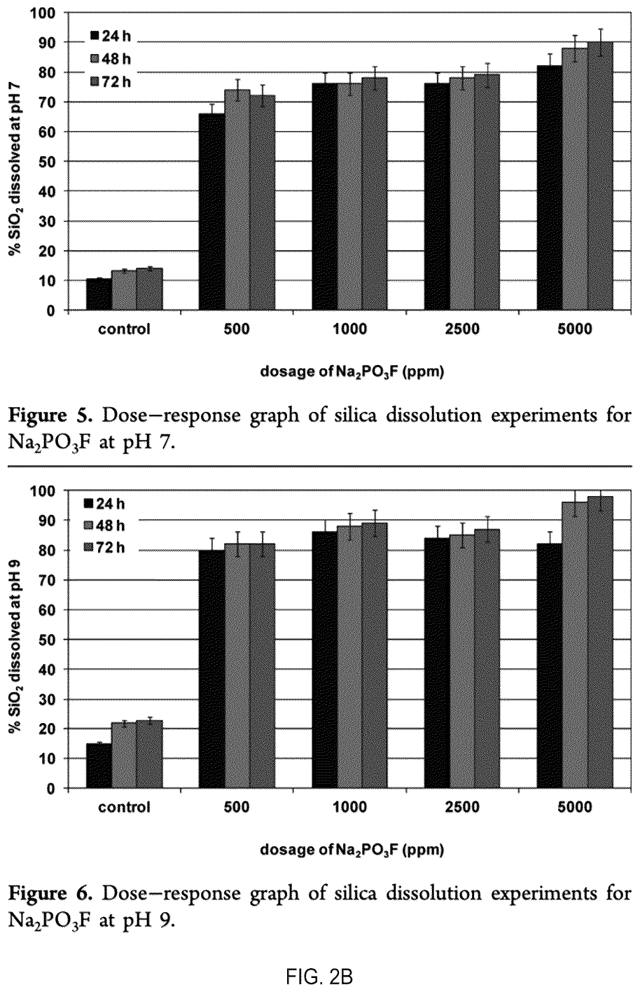

Various embodiments for purifying iron-bearing materials may include methods for controlling reactions of iron-bearing materials with an etching solution by controlling pH to reduce, or minimize, corrosion. In some embodiments, one may usefully manipulate the pH of the etching solution such that the iron-bearing materials are stable or corrode at a very low rate in the solution of interest. This may be applicable when an etchant can achieve a fast etching rate at a range of pH's where the corrosion of iron-bearing materials is minimized. Generally, the corrosion of iron may be minimized in light-to-medium alkalinity environments between pH's of 8-13 (see, for example FIG. 2A reproducing the diagram from Marcel Pourbaix's Atlas of Electrochemical Equilibria). One example of such an etchant which exhibits high etching activity at these pH's is Na₂PO₃F. FIG. 2B reproduces data from Demadis et al. demonstrating a high dissolution of silica in an aqueous solution with pH's 7 and 9. In general, there are many such buffered etching solutions containing fluorine, any of which may be used in various embodiments, and the pH of the solution may be tuned to co-optimize iron reactivity and silica dissolution rates.

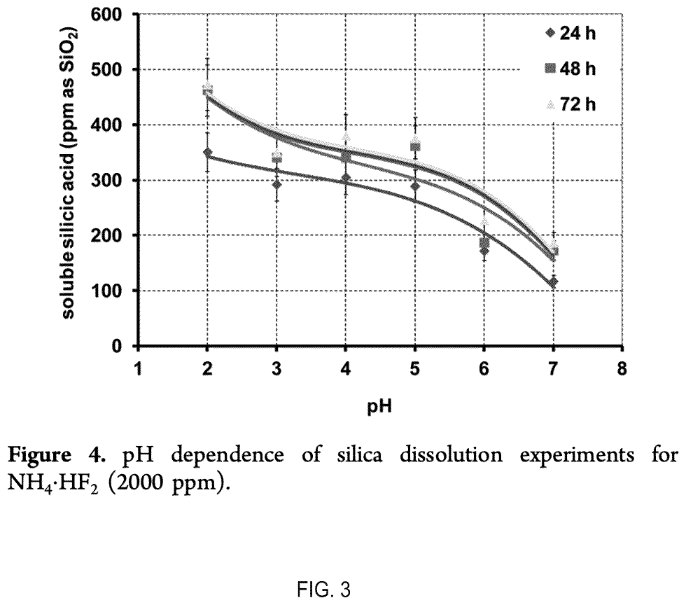

Various embodiments for purifying iron-bearing materials may include methods for controlling reactions of iron-bearing materials with an etching solution by controlling etchant chemistry to inhibit or eliminate corrosion. In some embodiments, the solubility (and relatedly, the etching rate) of silica may be a strong function of pH. Often, the etchants have higher solubility for silica and faster etching kinetics at pH's that are far away from neutral. In the case of HF and Ammonium Bifluoride etches, for example, the etchants for silica are most effective at more acidic pH's. This is illustrated by data shown in FIG. 3 reproducing data from Demadis et al. Normally, etching in acid would be at odds with preserving iron-bearing materials in the solid state, as iron and many of its compounds are known to dissolve in acidic solutions. In order to inhibit or eliminate this risk, soluble iron ions may be added to etchant. The presence of these ions will reduce the driving force for iron to dissolve into the solution. In some embodiments, one may usefully dissolve iron up to its solubility limit in the etchant such that the driving force for iron dissolution is entirely eliminated.

In some embodiments, the dissolved iron ions may be provided by the dissolution of a portion of the iron-bearing materials. The etching solution may be recycled in a closed loop to maximize the amount of iron-bearing materials that are preserved through the etching process.

In some embodiments, the dissolved iron ions may be provided by addition of a suitable soluble iron salt to the etchant, such as FeSO₄: ferrous sulfate; iron(II) sulfate FeCl₂: ferrous chloride; iron(II) chloride Fe(NO₃)₃: ferric nitrate; iron(III) nitrate Fe(SO₄)₃: ferric sulfate; iron(III) sulfate FeCl₃: ferric chloride; and/or iron(III) chloride.

Various embodiments for purifying iron-bearing materials may include ammonium bifluoride (NH4HF2) etching.

Various embodiments may include one or more materials and/or processes for leaching soluble species out of iron-based materials. Various embodiments may include silica dissolution with ammonium bifluoride (NH₄HF₂) techniques for dissolving impurities from iron-bearing materials.

Ammonium bifluoride may be used to dissolve silica-based impurities in iron-bearing materials, more specifically exposure of silica to ammonium fluoride or a mixture of ammonium fluoride and acid ammonium fluoride in an aqueous medium to produce ammonium silicofluoride. The ammonium silicofluoride may be subsequently precipitated to produce precipitated silica and potentially enable recycling of the ammonium bifluoride etchant, thereby enabling a closed-loop etching process through dissolution and precipitation of silica.

Ammonium fluoride (NH₄F) or ammonium bifluoride (NH₄HF₂) or acid ammonium fluoride (3NH₄·HF₂), or mixtures, solutions, and derivatives thereof, hereafter collectively referred to as AF, may be used to selectively dissolve silicates from iron-bearing ores and minerals, iron, and their partially processed intermediates. Without being bound by any particular scientific interpretation, the inventors believe that AF is able to dissolve or partially dissolve solid siliceous compounds. Compared to other chemical reagents that may dissolve silicates in the target iron-bearing materials such as hydrofluoric acid (HF), alkali metal hydroxides (including NaOH and KOH), and high temperature melts (for example, molten chlorides or fluorides or oxides), AF has the advantage of lower toxicity and greater safety than HF, and greater reactivity at lower temperatures and lower concentrations than the alkali metal hydroxides or high temperature melts.

As referred to herein, AF may comprise a solid compound or mixtures of solid compounds, a melt or partially molten form of said solid compounds, or AF that is dissolved in a liquid, said liquid comprising water, a polar solvent, a non-polar solvent, or a mixture of said solvents. The dissolved concentration of AF in the liquid solvent may range from a lower bound of 0.001 M to an upper bound of 20 M, is preferably in the range of 0.01 M to 10M, and still more preferably in the range 0.01 M to 5 M.

In some embodiments, the AF that is used to treat the iron-bearing material is used once and discarded or remediated or recycled after use. However, in preferred embodiments, a closed-loop process is used wherein the AF is regenerated and reused, decreasing or eliminating the need to supply additional AF to process new material. Examples of such a closed-loop process is now described, which may be conducted in a batch manner or as a continuous process.

Considering the use of NH₄F as the AF, a multi-stage reactor may have a first stage in which silica is dissolved. Without being bound by any particular scientific interpretation, the dissolution reaction is one which produces ammonia as a product, for example according to the reaction:

SiO₂+6NH₄F→(NH₄)₂SiF₆+2H₂O+4NH₃ (1)

Such reaction may be carried out in the temperature range from about 25° C. to about 110° C. To promote the forward reaction, the activity of the ammonia reaction product should be decreased. This may be done by separating the ammonia from the water by well-known methods, for example by distillation which takes advantage of the higher vapor pressure of ammonia.

In a second stage of the reactor, reaction (1) is reversed by increasing the activity of ammonia. An excess of the stoichiometric ratio of ammonia to ammonium silicofluoride of 4:1 is desirable. Thus, SiO₂ is reprecipitated, and NH₄F is produced. The solid precipitated SiO₂ may subsequently be separated from the liquid, for example by filtering or centrifugal separation, and discarded or beneficially used in another application.

Another possible reaction for which a similar reaction scheme may be used is:

SiO₂+6NH₄F→H₂SiF₆+2H₂O+6NH₃ (2)

As another example, consider the use of ammonium bifluoride, NH₄HF₂ in a similar scheme. Ammonium bifluoride may dissolve silica according to the reaction:

SiO₂+4NH₄HF₂→(NH₄)₂SiF₆+2NH₄F+2H₂O (3)

Or:

SiO₂+4NH₄HF₂→SiF₄+4NH₄F+2H₂O (4)

Or:

SiO₂+3NH₄HF₂→H₂SiF₆+3NH₃+2H₂O (5)

With reaction 5, a similar reaction scheme to that described above for ammonium fluoride may be used to dissolve and then precipitate SiO₂, thereby removing it from the iron-bearing material.

Embodiments of the invention include the above described methods for dissolving and reprecipitating a silicate from said iron-bearing materials. The invention also includes multi-stage reactors for carrying the dissolution reaction, removing and capturing products of the dissolution reaction and supplying them to a later stage precipitation reactor. The invention also includes systems for carrying out such processes, which include a source of iron-bearing material and of AF, a reactor or reactors carrying out the dissolution and reprecipitation process, and a subsystem for separating the processed solid siliceous material from the liquid and optionally drying the solids, and optionally delivering the processed iron to a manufacturing operation for various products including without limitation iron, steel, and electrochemical batteries using said iron-bearing materials. Such a system may be operated in whole or in part using renewable energy, including low embodied carbon electricity sources.

The siliceous material present in the iron-bearing material (referred to as “gangue”) may not be pure silica and may include other constituents that are soluble in acids or bases alongside the silica which is soluble when reacted with AF. An example is calcium silicate, wherein the calcium component is soluble in acid (for example, HCl or HNO₃ or H₂SO₄) while the silica is soluble with AF. Generally, the leaching or dissolution of one phase will accelerate the leaching or dissolution of the other phase. Accordingly, an acidic solution also containing AF may be used to simultaneously leach or react said calcium silicate. Optionally, when phases are present that are each preferentially leached by one of the reactants, a sequential process may be used. For example, in the example of calcium silicate, the iron may be first reacted with acid to dissolve or partially dissolve the calcium constituent, and subsequently with AF to dissolve or partially dissolve the silica component, or the order of operations may be reversed.

According to some embodiments, any of the chemical dissolution reactions described herein may be supplemented with mechanical energy, for example through grinding or milling. As an example, an iron ore material undergoing leaching with AF solution or with acid may be simultaneously ground using, for example, ball milling or attritor milling, to increase the efficiency or rate of the chemical reaction(s).

Various embodiments may include one or more materials and/or processes for leaching soluble species out of iron-based materials. Various embodiments may include silica dissolution with chemical reagent techniques other than AF for dissolving impurities from iron-bearing materials, such as using hydrofluoric acid (HF), alkali metal hydroxides (including NaOH and KOH), and/or high temperature melts (for example, molten chlorides or fluorides or oxides) to dissolve silica and/or remove other impurities from iron-bearing materials.

Various embodiments for purifying iron-bearing materials may include using a flux, such as NABO₂, LiBO₂, Li₂B₂O₇, etc.

Various embodiments may include one or more materials and/or processes for leaching soluble species out of iron-based materials. Various embodiments may include silica dissolution via the addition of a flux (e.g., a glass fluxing agent). One example of a flux is a metaboric salt.

In a first embodiment, a flux is added to an iron material, the iron material comprising silica. The silica in the iron material forms a fluxed silica material. In a first embodiment, a fluxed silica material is heated to a melting point (liquidus) of the fluxed silica material, said melting point below an iron melting point. In this way, the fluxed silica material may be separated from the iron material.

In one embodiment, the molten silica is separated from the iron-rich material by preferential wicking of the silica into a porous substrate that has a lower contact angle for the fluxed silica phase than the iron-bearing materials. In this way, the porous substrate may act as a high temperature sponge with which to soak up the fluxed silica material. The porous substrate may be a higher-melting phase of silica.

In some embodiments, an iron-based ore concentrate may be purified by any of the methods described herein to achieve lower impurity contents, with a focus on the reduction of silica, calcia, and alumina-containing impurities. The iron-based ore concentrate may then be used directly in the fabrication of an electrode as an active material, rather than processing the iron ore to form a reduced iron species. In this manner, the ore materials may be used to fabricate an electrode using the methods common in the art for forming an electrode from a non-conducting or semiconducting active materials. In some embodiments, the iron-based ore concentrate maybe be a magnetite ore concentrate, thereby usefully taking advantage of the semiconducting nature of magnetite to ease electronic transport through the battery electrode. In some embodiments, the iron-based ore concentrate may be combined with any of a binder and a conductive additive. The binder may be any binder system useful for fabricating iron electrodes for use in alkaline environments, including carboxymethylcellulose (CMC), polyacrylic acid, and/or teflon. The conductive additive may be any conductive additive known in the art to enhance electronic transport in alkaline battery electrodes, including but not limited to carbon blacks or graphites. The formulation may be composed of 94% by weight iron ore based concentrate, 3% conductive additives, and 3% binder.

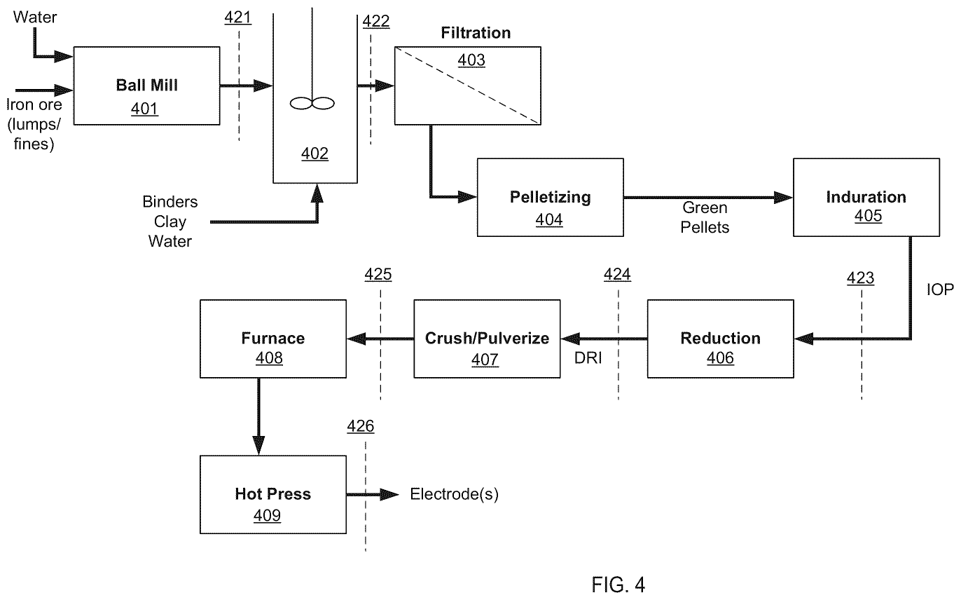

FIG. 4 is a block diagram illustrating processing operations and devices for processing iron ore into battery components, such as electrodes, and opportunities for silica removal along the iron ore process in accordance with various embodiments. For example, FIG. 4 may illustration specific examples of example operations discussed with reference to FIG. 1B. FIG. 4 illustrates that iron ore, such as in the form of lumps and/or fines, may be milled, crushed, and/or ground, such as by a ball mill 401. As an example, water may be added to the ball mill 401 to result in a slurry of milled iron leaving the ball mill 401. The milled iron ore may pass to a mixing tank 402 in which various additives may be added to the slurry of milled iron ore, such as binders, clay, and/or water. The milled iron ore and additives combined in the mixing tank 402 may result in a blended iron concentrate which may be filtered in one or more filtration units 403. Filtration may remove unwanted materials and/or liquid from the blended iron concentrate. Filtration may result in a cake material. The cake material of blended iron concentrate may undergo a pelletizing process 404 resulting in green pellets which may undergo an induration process 405 to form iron ore pellets (IOPs). IOPs may proceed to a reduction process 406 and be formed into DRI pellets that may be crushed and/or pulverized in a crushing/pulverization process 407. The crushed/pulverized DRI may proceed to a furnace 408 for heating and may undergo a hot pressing process 409 to result in a battery component being formed, such as one or more electrodes.

In various embodiments, chemical purification processes, such as silica, alumina, calcia, magnesia, and/or manganese oxides chemical removal processes may occur at process points 421, 422, 423, 424, 425, and/or 426 in the processing of the iron ore into DRI and into a battery component, such as an electrode. For example, process point 421 may be chemical silica removal after wet milling of the iron ore. For example, process point 422 may be chemical silica removal after blending and the addition of binders and/or fluxes to the iron concentrate. For example, process point 423 may be chemical silica removal from the IOPs. For example, process point 424 may be chemical silica removal from DRI pellets. For example, process point 425 may be chemical silica removal from crushed/pulverized DRI. For example, process point 426 may be chemical silica removal from the battery component form factor after assembly of the batter component, such as chemical silica removal from an electrode form factor after assembly of the electrode.

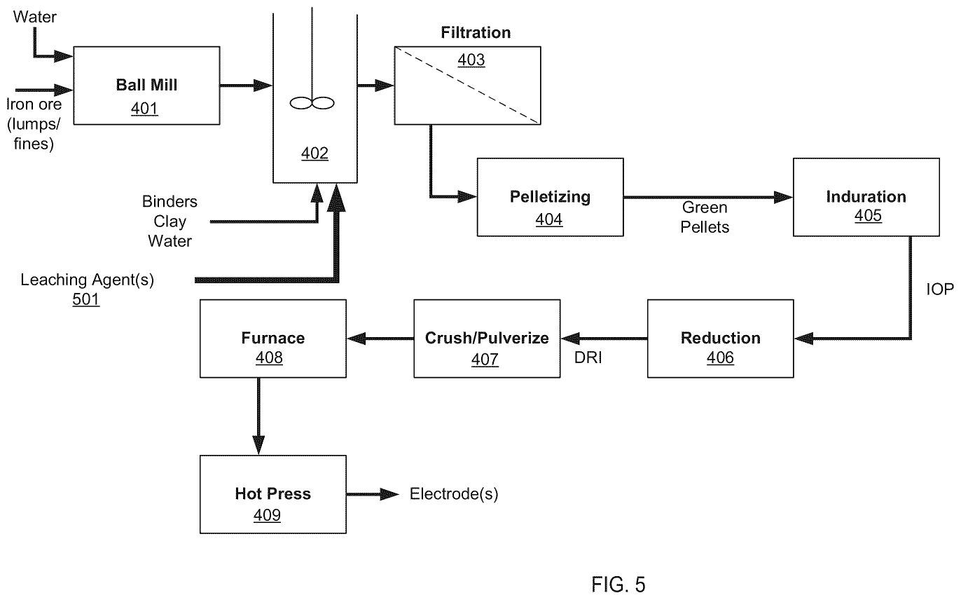

FIGS. 5-11 illustrate example processes for removing impurities, such as silica, alumina, calcia, magnesia, and/or manganese oxides, from iron-bearing materials in accordance with various embodiments. As an example, the processes illustrated in FIGS. 5-11 may be performed as part of the processing operations and devices for processing iron ore into battery components, such as electrodes, illustrated in FIG. 4.

FIG. 5 illustrates an example operation in accordance with various embodiments in which one or more etching/leaching agents 501 to remove impurities, such as silica, alumina, calcia, magnesia, and/or manganese oxides, from iron-bearing materials may be introduced into the concentrate mixing tank 402. For example, an acid may be introduced into the tank 402. Introduction of one or more etching/leaching agents 501 into the mixing tank 402 may represent a simplest process modification to remove impurities, such as silica, alumina, calcia, magnesia, and/or manganese oxides, from iron-bearing materials.

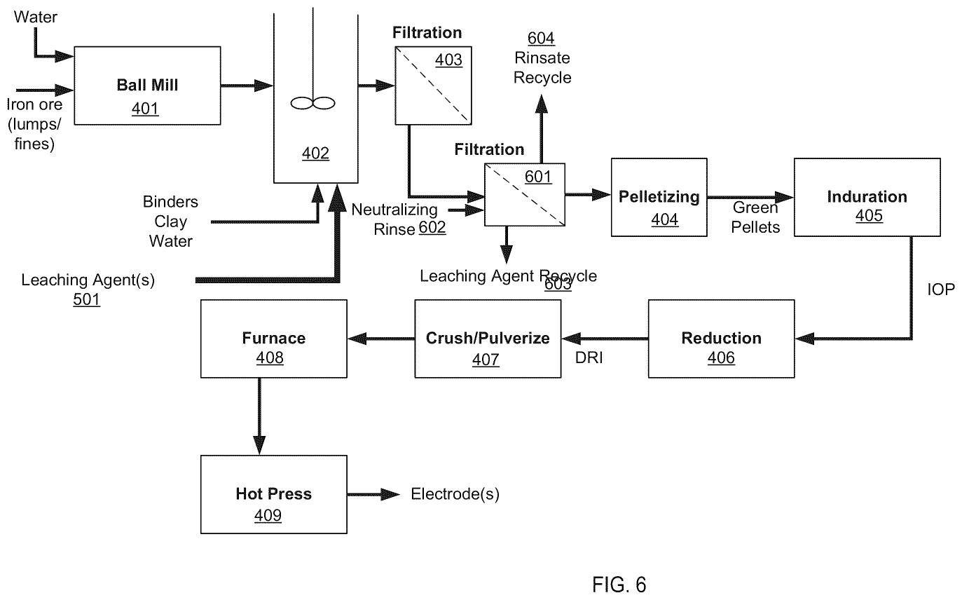

FIG. 6 illustrates an example operation similar to that of FIG. 5, in which a second filtration step 601 is used in order to rinse the filter cake with a neutralizing agent 602. The second filtration step 601 including the neutralizing agent 602 rinse may avoid diluting the recycle stream. The filtration step 601 may result in a rinsate recycling stream 604 and etching/leaching agent recycling stream 603.

In various embodiments, heat may be added to the system to assist in the chemical etching and/or leaching processes. For example, heat may be added to the mixing tank 402, following the mixing tank 402 (e.g., in flow reactor), and/or during a filtration process.

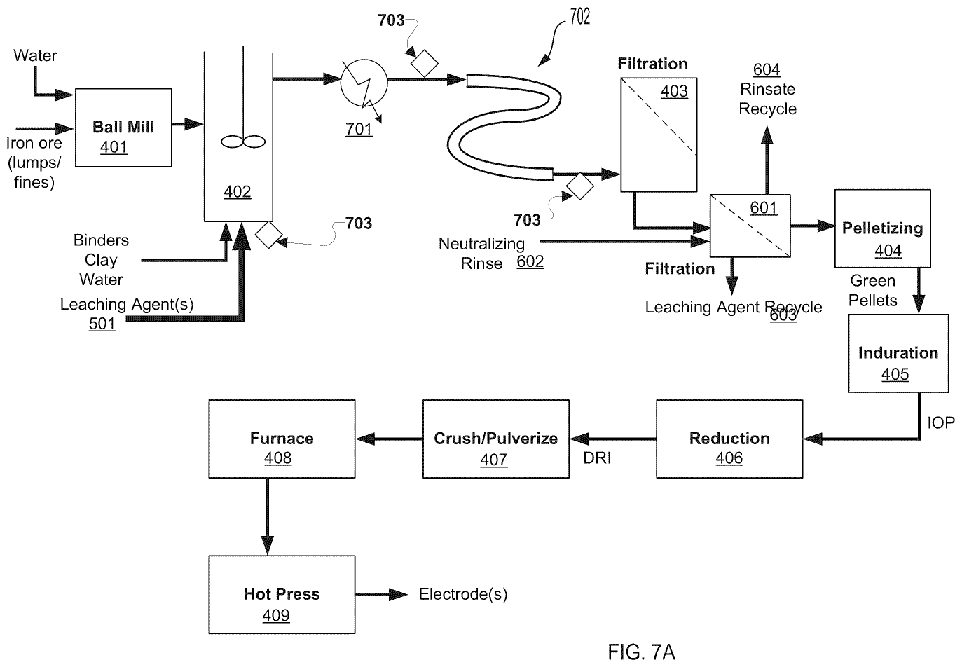

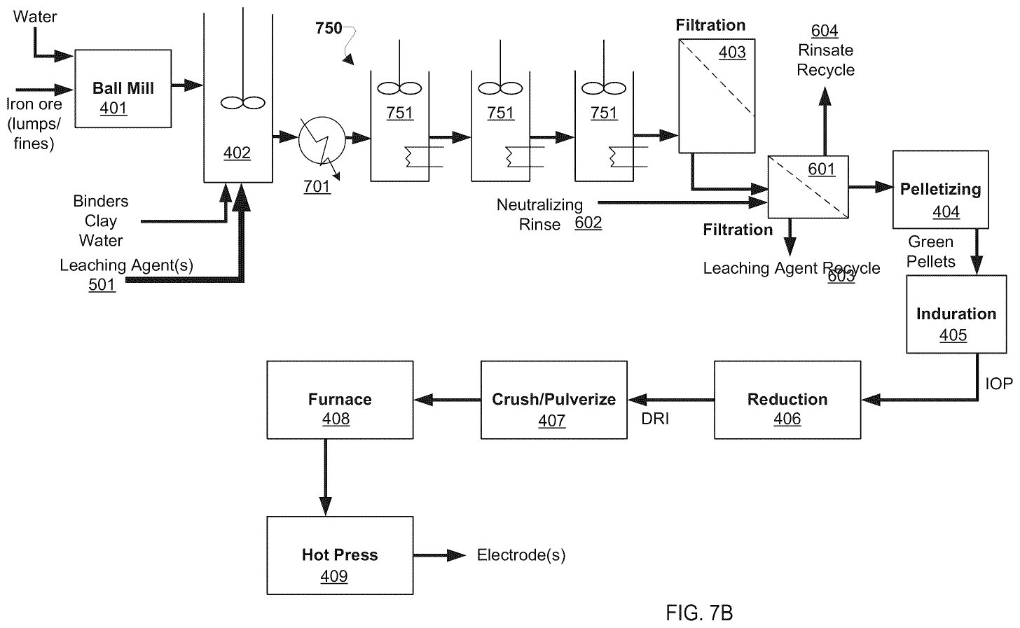

FIG. 7A illustrates another example configuration similar to that of FIG. 6. Specifically, FIG. 7A illustrates an example operation in accordance with various embodiments in which one or more etching/leaching agents 501 to remove impurities, such as silica, alumina, calcia, magnesia, and/or manganese oxides, from iron-bearing materials may be introduced into the concentrate mixing tank 402 and heat may be added to support the etching/leaching chemistries removing the SiO₂ without dissolving Fe species. For example, FIG. 7A illustrates heat added upstream of the mixing tank 402 (also sometimes referred to as a reaction vessel) by a plug flow reactor 702. The concentrate stream leaving the mixing tank 402 may be heated by a heater 701 and the reaction of the etching and/or leaching agents 501 to target SiO₂ may occur in the plug flow reactor 702. Heat may be added by the heater 701 in the mixing tank 402, upstream of the plug flow reactor 702 after the mixing tank 402, and/or directly in the plug flow reactor 702. In some embodiments, a double pipe exchanger configuration for the plug flow reactor 702 may be used in which the concentrate stream leaving the mixing tank 402 passes through the interior pipe and a heating medium is passed through the annulus. This configuration may be preferred where the reaction of the etching and/or leaching agents requires a short, precise duration. The annulus may be segmented into various heating and cooling zones. Temperature sensors 703 may be included in the system to monitor the temperature of the concentrate stream in the mixing tank 402, prior to entry into the plug flow reactor 702, and/or after exit from the plug flow reactor 702.

FIG. 7B illustrates another example configuration similar to that of FIG. 7A in which the plug reactor 702 is replaced by a pseudo plug flow reactor 750 formed from a series of stirred vessels 751, such as one or more stirred vessels 751, three stirred vessels 751, more than three stirred vessels 751, etc. Each stirred vessel may include its own heating coil and may controllably provide heat to the concentrate stream as the concentrate stream passes through the vessels 751. The pseudo plug flow reactor 750 may provide less heating precision than a true plug flow reactor 702, but the pseudo plug flow reactor 750 may still enable heat to be added to the concentrate stream to support the etching/leaching chemistries removing the SiO₂ without dissolving Fe species.

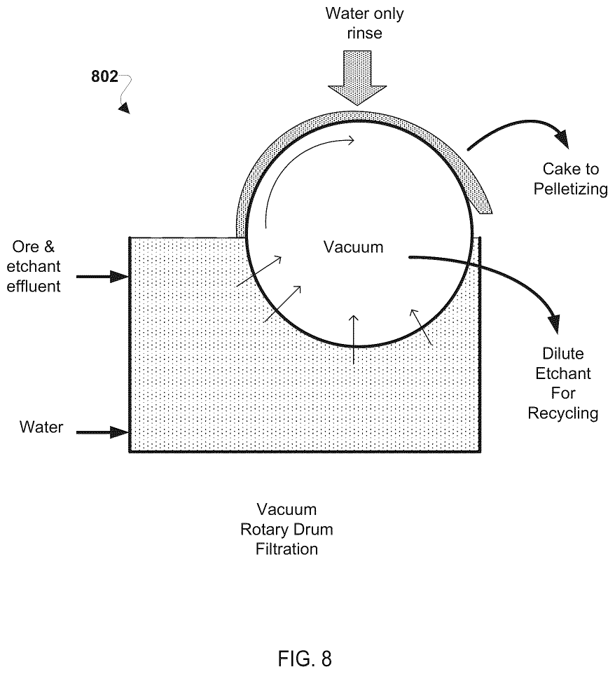

FIG. 8 illustrates a rotary drum filter and rinse process 802 that may be incorporated into a filtration operation, such as the filtration operations 403 and/or 601 described above. By the rotary drum filter and rinse processor 802, the etching/leaching solution may be diluted but the potential for recycling may not be reduced.

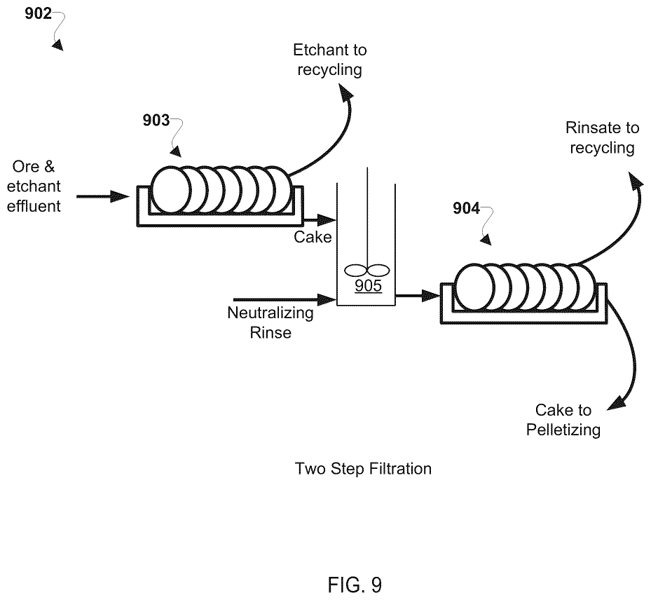

FIG. 9 illustrates a two step filtration process 902 that may be incorporated into a filtration operation, such as the filtration operations 403 and/or 601 described above. As illustrated in FIG. 9, a neutralizing agent may be added to the rinse step. In this embodiment, a two step filtration process is employed. The first filtration 903 removes the majority of the etching/leaching solution for recycling. The filter cake may then be mixed with a neutralizing rinse solution in a mixing tank 905. The second filtration 904 removes the rinsate and prepares the concentrate for pelletization. Ceramic disk filters may be one example of filters that may be used in the first filtration 903 and/or second filtration 904. Ceramic disk filters may be preferred for this embodiment due to their increased throughput capacity. However, other filter media and/or filter processes may be substituted for the ceramic disk filters in various embodiments.

In embodiments where the iron is purified in a larger format, at either the IOP, DRI pellet, crushed DRI or electrode slab stage of the production line, full or partial submersion process, such as a single or multi-stage bath, fixed bed silo, spiral conveyor, and/or other type process, may be used to apply etching and/or leaching solution to iron material. For example, a bath with a submerge conveyor may be used to expose the iron material to an etchant. A bath with a submerged conveyor moving at a controllable speed may enable exceptional duration precision. As another example, a spiral conveyor in which iron material is moved through a liquid etchant may be used to expose the iron material to an etchant. As another example, fixed bed silos may be used to expose the iron material to an etchant. In various embodiments, a water rinse may be incorporated into the process to rinse the iron material after removal from the etching solution. In various embodiments, the etching solution, such as the etching solution bath, spiral conveyor liquid, fixed bed silo, etc., may or may not be heated. In various embodiments, a full or partial submersion process, such as a single or multi-stage bath, fixed bed silo, spiral conveyor, and/or other type process, may be used to apply etching and/or leaching solution to iron material at or after any of the processes 404-409 described with reference to FIG. 5. In various embodiments, the etchant/leaching solution may be continuously, or intermittently, circulated in a full or partial submersion process, such as a single or multi-stage bath, fixed bed silo, spiral conveyor, and/or other type process, through a regeneration process which may precipitate the etched or leached material, such as silica, alumina, calcia, magnesia, and/or manganese oxides, from the etchant/leaching solution thereby recharging the etchant/leaching solution.

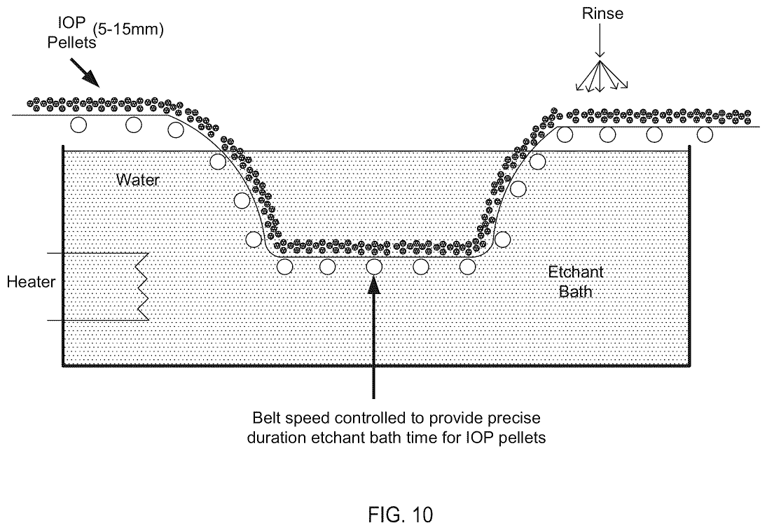

FIG. 10 illustrates an example etchant batch process in which IOP pellets, for example IOP pellets ranging from about 5 mm to about 15 mm in size, on a conveyor are submerged in an etchant bath by the conveyor path and under a water rinse after exiting the etchant bath. The speed of the belt of the conveyor may be controlled to ensure a precise duration of exposure of the IOP pellets to the etchant bath.

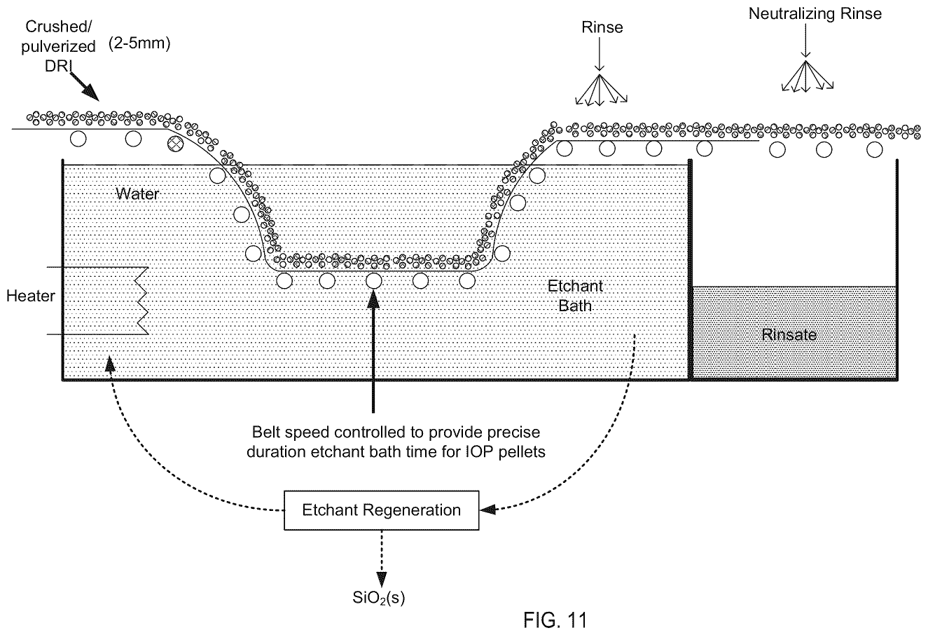

FIG. 11 illustrates an example etchant batch process in which crushed and/or pulverized DRI pellets, for example DRI pellets ranging from about 2 mm to about 5 mm in size, on a conveyor are submerged in an etchant bath by the conveyor path and under a water rinse after exiting the etchant bath. The DRI pellets may pass under a second neutralizing rinse step which may be portioned from the etchant bath. The speed of the belt of the conveyor may be controlled to ensure a precise duration of exposure of the DRI pellets to the etchant bath. The etchant bath solution may be continuously circulated from the bath through a regeneration process which may precipitate the silica out of the etchant bath solution.

Stannate can be a performance-enhancing additive for iron negative electrodes. In some circumstances, the performance-enhancing effect of the stannate requires the stannate to be soluble. Stannate concentrations between 1-300 mM are often desirable to enhance the performance of iron negative electrodes in alkaline media.

Some impurities in iron electrode active materials or other parts of the cell may precipitate the stannate such that the stannate attains a solubility below the solubility desired for enhanced electrochemical performance. Additionally, or alternatively, the precipitation of stannate from the soluble state to the insoluble state may result in cost increases for the stannate-containing additives in order to achieve the same level of performance in the absence of stannate precipitation.

Various embodiments include methods for limiting or eliminating the precipitation of the stannate from the electrolyte.

In addition to the motivation specific to stannate, there is a more generalizable problem to be solved with these methods. The more general problem is that whenever an impurity exists in an electrochemical cell, the impurity has the potential to react with the electrolyte or the electrodes to cause deviations in electrochemical performance. Therefore, in general, one desires to control the composition of everything in the cell, and/or to assure that impurities do not react with the rest of the cell.

Various embodiments include methods and systems for removing impurities from materials that go into an electrochemical cell. Various embodiments include methods and systems for passivating or reacting impurities such that they cannot interact with the rest of the cell.

Stannate can precipitate on materials that form stable compounds in the presence of tin in alkaline solution. As outlined below, sometimes such stable compounds can be used to usefully constrain the loss of stannate. However, other elements may form compounds with tin in the presence of alkaline solutions such that the amount of tin in solution is permanently lessened. Calcium, magnesium, aluminum, and manganese may all form stable compounds in the presence of stannate, among others. More specifically, CaO, MgO, Al₂O₃, and Mn-based oxides may all react with stannate to produce metal-stannate compounds with low solubility in alkaline solutions relative to the desired concentrations for enhanced iron electrode performance.

In general, it is often useful to remove impurities from electrode materials to prevent deleterious interactions with the electrochemical behavior of the cell. As an example, in some cases, it is useful to remove the impurities that cause precipitation of stannate when using iron negative electrodes in alkaline solution.

In the case of an electrode active material with these impurities, the removal of these impurities can be accomplished by dissolution of the impurities or other processing of the materials prior to placing the electrode active materials in contact with the stannate-containing solution.

Various embodiments may include the removal of impurities through dissolution.

Ca and Mg commonly come as impurities to low-cost iron materials, usually in the form of CaO/MgO and/or their hydroxides (Ca(OH)₂ and Mg(OH)₂. As the oxides CaO and MgO convert to their hydroxides in aqueous solution, it is the inventors' experience that the oxides (CaO, MgO) may be treated in an identical manner to the hydroxides in terms of their dissolution/reaction behavior in aqueous solution.

CaO and MgO are basic oxides and may be dissolved in acids easily. Therefore, an acid can be used to remove the materials from solution. If an acid is used to dissolve these oxides from iron-containing active materials, the acid solutions may need to be appropriately buffered to selectively leach CaO and MgO with the acid while preserving much of the iron-containing active material. Ca(OH)₂ begins to be soluble even at highly basic pH's (˜13 for low solubility, with pH 11.5 needed for higher solubility), but in order to drive the dissolution forward, an acidic component of the etching solution is needed. Similarly, Mg(OH)₂ is soluble at pH's below ˜11, and highly soluble below pH ˜8.

Similar considerations apply to the removal of other impurities that can be dissolved with acids, such as Al₂O₃ and Mn-based oxides. As such, the various acid based embodiments discussed below in relation to removal of CaO and MgO and/or their hydroxides (Ca(OH)₂ and Mg(OH)₂, may apply to removal of other impurities, such as Al₂O₃ and Mn-based oxides. Accordingly, in the various examples discussed below in relation to removal of impurities CaO and MgO and/or their hydroxides (Ca(OH)₂ and Mg(OH)₂, other impurities, such as such as Al₂O₃ and Mn-based oxides, may be substituted for the CaO and MgO and/or their hydroxides (Ca(OH)₂ and Mg(OH)₂, and the various embodiments may be used to remove such other impurities.

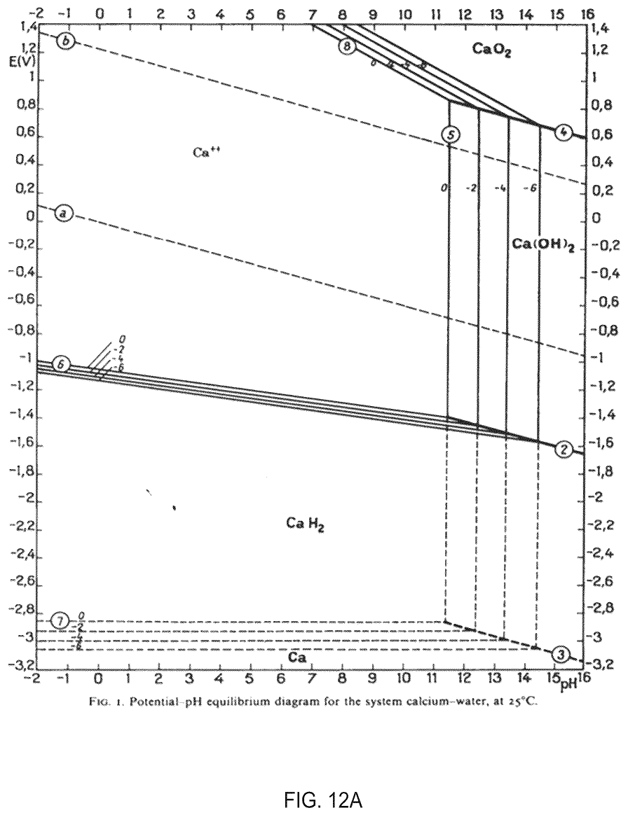

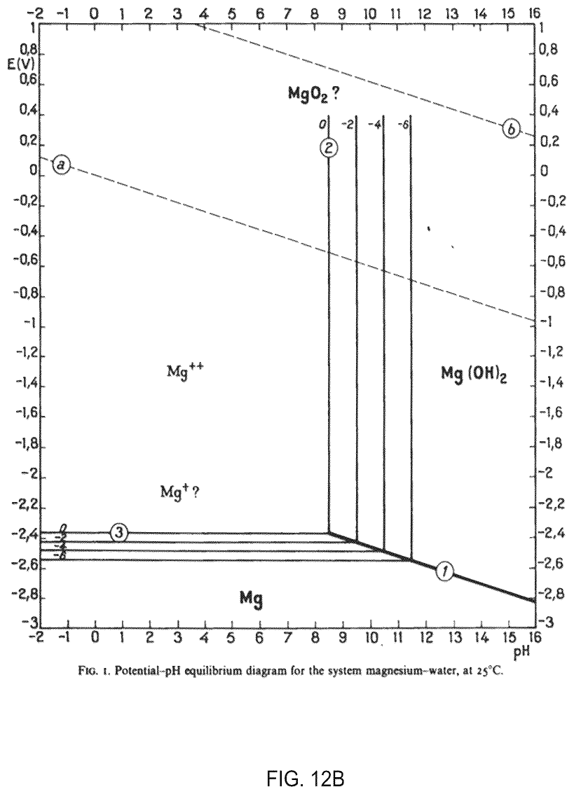

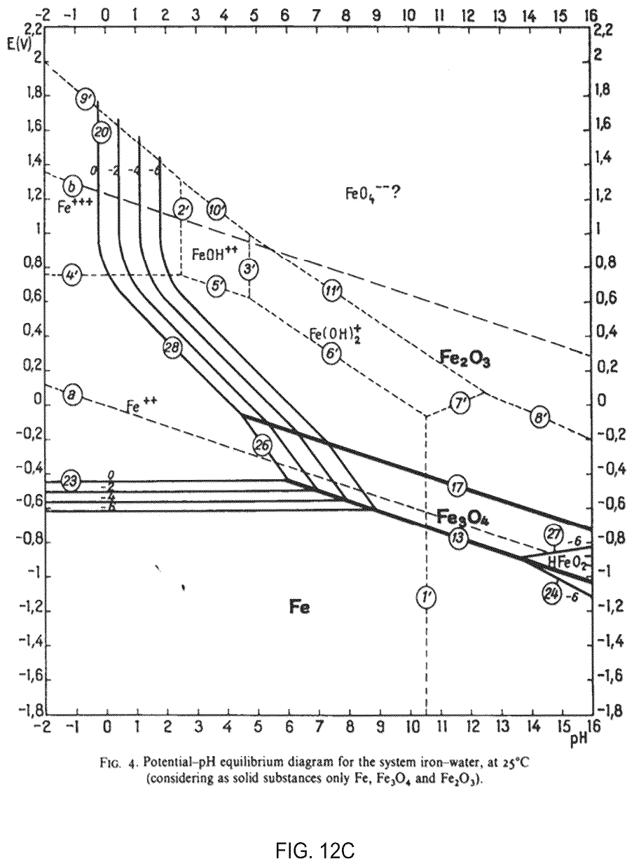

FIGS. 12A-12C are Pourbaix diagrams illustrating the range of pH's over which Ca and Mg-based aqueous solutions begin to have high solubility of Ca and Mg, and comparison to that of iron.

Various embodiments may include etching solutions to remove impurities, such as one or more of CaO and MgO and/or one or more of their hydroxides (Ca(OH)₂ and Mg(OH)₂.

Ideally, a solution for treating iron active materials would have limited reactions with the iron active materials being treated, while exhibiting fast reactions with and high solubility for the impurities being removed. Many solution configurations are possible, depending on the iron active material being treated. As shown by the Pourbaix diagrams in FIGS. 12A-12C, iron will dissolve in low pH solutions (<˜5), and these are generally not preferred solutions for treating iron active materials. However, there are pH ranges where iron is passivated and/or has very slow corrosion rates which overlap with the pH ranges with high solubility for Mg and Ca, specifically pH ˜5-10. It will be recognized by one skilled in the art that the pH ranges given above are approximate and subject to many considerations around other experimental factors.

While many different acids may be used to remove CaO and MgO from iron electrode materials, there are preferred acid chemistries for performing such a dissolution process. Specifically, weak or buffered acid chemistries that result in pH's in the preferred range of 5-10 are desired. The anion used for the acid should be selected to minimize the corrosion of iron and to be compatible with the electrochemical cell if some small contamination occurs. For example, if the etching is performed on iron ore concentrate, acids that are able to be volatilized in a furnace in subsequent processing (like nitric acid) are preferred. Hydrochloric acid is generally not desired as contamination with chloride ions can be detrimental to iron electrode performance and electrochemical cell performance more generally. Sulfuric acid etches may be used on active materials that are etched prior to entering the electrochemical cell, as sulfate ions are often not detrimental to iron electrode performance in small quantities. In all cases, the materials should be rinsed or otherwise purified after the etching process to assure other impurities do not enter the cell. The buffer chosen for the etching will be a function of the targeted pH range, but some examples may include carbonic acid/bicarbonate, acetic acid, C₆H₁₃NO₄S, and any of the many other buffers common in the art.

Various embodiments may include controlling an amount of dissolved iron to extend the stability domain of iron.

The range of pH's where the rate of iron etching/corrosion is low is a function of the amount of dissolved iron in solution, with higher concentrations of dissolved iron extending the pH range of passivation and lowering the corrosion rate of iron. Iron ions may therefore be intentionally added to extend the range of pH's over which iron does not appreciably etch, thereby permitting faster kinetics for the etching of Mg and Ca-based compounds by operating the dissolution process at lower pH's. The dissolved Fe concentrations needed to gain enhanced passivation increase exponentially with linearly decreasing pH.

Various embodiments may include adding corrosion inhibitors to lower the corrosion rate of iron.

In many practical circumstances, impurities may be removed from iron in solutions that are nominally corrosive to iron, albeit at slow rates. In such circumstances, corrosion inhibitors may be added to the etching bath to stabilize the iron from corroding. Additionally or alternatively, the iron materials to be treated may be treated with the corrosion inhibitor before allowing the iron material to come in contact with the etching solution. Depending on the solution chemistry, many corrosion inhibitors may be used, including thiourea, sulfides (e.g., sodium sulfide), silicates, or other thiolated organics (e.g., hexanethiol, heptanethiol, octanethiol, etc.).

Various embodiments may include recycling of the etching solution. In some circumstances, the etchant can be purified and re-used continuously. For example, the etchant may be exposed to a material that precipitates the impurity being removed. In some instances, the Mg and Ca can be precipitated by exposure to carbonate ions formed from bubbling of CO₂ through the enchant to form calcium and magnesium carbonate. In other cases, the impurities may be precipitated by exposure to other counterions that cause low solubility of the dissolved impurity, such as fluoride or phosphate ions. In other cases, the solution may be passed through any other processes known in the art for selective removal of ions, including the use of reverse osmosis and ion-selective membranes.

Various embodiments may include passivating impurities.

In some instances, the impurities may be passivated or reacted such that they no longer can react with the electrolyte, thereby limiting the ability of the impurities to detrimentally impact electrochemical performance. In one example, the impurities may be treated with low-solubility, passivating ions. In the case of calcium and magnesium, fluoride and phosphate ion treatment may be used to form low Ksp (solubility product) compounds that have little to no solubility and are highly stable, thereby preventing the reactions of these materials with the other components of the electrochemical cell. In some instances, the treatment process may take place before the impurities enter the cell. In other instances, the treatment may be performed when the material enters the cell by having a treating material in the electrolyte or otherwise incorporated into the cell.

In some instances, passivation of the surface of the impurity particles may occur through adsorption of species that do not form low Ksp compounds. For example, aluminates or silicates may be added to the solution to form passivating films on the Ca and Mg through formation of surface layers of calcium silicate hydrate, magnesium silicate hydrate. Crucially, the entirety of the CaO or MgO particle need not react to be effectively passivated.

Various embodiments may include reacting the impurities that can cause precipitation with compounds that preferentially react with the impurity such that stannate is preserved in solution.

In some circumstances, one may prevent the precipitation of stannate through causing another reaction to take place instead of stannate precipitation. This can be accomplished by adding a co-additive with the stannate such that the calcium or magnesium preferentially reacts with the co-additive instead of the stannate. Fluoride ions, phosphate ions, and carbonate ions may all be used to form stable compounds with Mg and Ca in solution. The material added to preferentially react with the Ca may be added at beginning of life of the battery cell, or may be dosed or otherwise slowly introduced during operation to allow reactions to take place without too high an instantaneous concentration of the co-additive in the electrolyte.

Various embodiments may include a method for purifying iron-bearing materials, comprising: leaching one or more soluble species of impurities out of iron-bearing materials, wherein the leaching comprises leaching with a leaching solution comprising fluorine. In various embodiments, the leaching solution comprises ammonium fluoride (NH₄F) or acid ammonium fluoride (3NH₄·HF₂), or mixtures thereof. In various embodiments, the leaching solution comprises ammonium bifluoride (NH₄HF₂). In various embodiments, the leaching comprises dissolving impurities using hydrofluoric acid (HF), alkali metal hydroxides (e.g., NaOH and KOH), and/or high temperature melts (for example, molten chlorides or fluorides or oxides). In various embodiments, the leaching solution comprises sodium fluorophosphate (Na₂PO₃F). In various embodiments, the fluorine containing component of the leaching solution has a molar concentration between 100 and 10000 ppm. In various embodiments, the fluorine containing component of the leaching solution has a molar concentration between 500 and 5000 ppm. In various embodiments, the iron-bearing materials are iron ores, iron, and/or their intermediates. Various embodiments may further include controlling a pH of the leaching solution. In various embodiments, the pH is controlled to be in a range of 8 to 13. In various embodiments, the pH is controlled to be in a range of 7 to 9. In various embodiments, the pH is controlled to be in a range of 5 to 10. Various embodiments may further include adding a soluble iron salt to the leaching solution. In various embodiments, the iron salt comprises one or more of ferrous sulfate; iron(II) sulfate, ferrous chloride, ferric nitrate, ferric sulfate, and/or ferric chloride. Various embodiments may further include adding iron ions to the leaching solution. Various embodiments may further include adding one or more corrosion inhibitors to the leaching solution. Various embodiments may further include recycling the leaching solution. Various embodiments may include a method for purifying iron-bearing materials, comprising: leaching one or more soluble species of impurities out of iron-bearing materials, wherein the leaching comprises dissolution via addition of a flux. Various embodiments may further include forming an electrode of a battery using the purified iron-bearing materials. Various embodiments may further include providing the battery into a bulk energy storage system. In various embodiments, the bulk energy storage system is a long duration energy storage (LODES) system. Various embodiments may include a battery and/or a bulk energy storage system, comprising at least one electrode formed at least in part according to the operations of the methods of this paragraph.

Various embodiments may include a method for ameliorating the detrimental effects of an impurity in an iron electrode comprising: passivating an impurity in the iron-bearing material such that passivated impurity no longer reacts with an electrolyte of a battery in which the iron-bearing material will be used. Various embodiments may include a method for ameliorating the detrimental effects of an impurity in an iron electrode comprising: adding a co-additive to the iron-bearing material that preferentially reacts with an impurity in the iron-bearing material instead of a stannate added to the iron-bearing material. In various embodiments, the impurity comprises calcium or magnesium. In various embodiments, the co-additive comprises fluoride ions, phosphate ions, and/or carbonate ions. In various embodiments, the methods discussed in this paragraph may be performed in conjunction with one or more of the methods discussed in the previous paragraph. In various embodiments, the purifying of the iron-bearing materials is performed at one or more stages in the processing of iron ore for forming a battery component. In various embodiments, the one or more stages include prior to, during, and/or after milling, blending, adding binders, adding fluxes, filtration, pelletizing, induration, forming iron ore pellets (IOPs), reduction, forming direct reduced iron (DRI) pellets, crushing, pulverizing, heating, hot pressing, and/or forming a battery component. In various embodiments, the battery component is an electrode. In various embodiments, the purifying comprises adding an etching and/or leaching agent to a concentrate mixing tank, rinsing a filter cake with a neutralizing agent, heating a concentrate stream with an etching and/or leaching agent added, rotary drum filtering, two step filtration, partially submerging iron material in an etching and/or leaching solution, fully submerging iron material in an etching and/or leaching solution, and/or regenerating an etching and/or leaching solution. Various embodiments may include forming an electrode of a battery using the purified iron-bearing materials. Various embodiments may further include forming an electrode of a battery using the purified iron-bearing materials. Various embodiments may further include providing the battery into a bulk energy storage system. In various embodiments, the bulk energy storage system is a long duration energy storage (LODES) system. Various embodiments may include a battery and/or a bulk energy storage system, comprising at least one electrode formed at least in part according to the operations of the methods of this paragraph.

Various embodiments may include a method for purifying iron-bearing materials, comprising: etching and/or leaching one or more soluble species of impurities out of iron-bearing materials, wherein the impurities comprise silica, alumina, magnesia, manganese oxides, and/or calcia. In various embodiments, the leaching comprises alkaline leaching. In various embodiments, the leaching comprises acidic leaching. In various embodiments, the leaching comprises dissolution via addition of a flux. In various embodiments, the leaching comprises dissolving impurities using ammonium fluoride (NH₄F) or ammonium bifluoride (NH₄HF₂) or acid ammonium fluoride (3NH₄·HF₂), or mixtures, solutions, and derivatives thereof, hereafter collectively referred to as AF. In various embodiments, the leaching comprises dissolving impurities using hydrofluoric acid (HF), alkali metal hydroxides (e.g., NaOH and KOH), and/or high temperature melts (for example, molten chlorides or fluorides or oxides). In various embodiments, the iron-bearing materials are iron ores, iron, and/or their intermediates. In various embodiments, the etching comprises ammonium bifluoride (NH₄HF₂) etching. In various embodiments, the etching comprises etching with an etchant comprising fluorine. In various embodiments, the etching comprises etching with sodium fluorophosphate (Na₂PO₃F). Various embodiments may further include controlling a pH of the etching solution. In various embodiments, the pH is controlled to be in a range of 8 to 13. In various embodiments, the pH is controlled to be in a range of 7 to 9. In various embodiments, the pH is controlled to be in a range of 5 to 10. Various embodiments may further include adding a soluble iron salt to the etching solution. In various embodiments, the iron salt comprises one or more of ferrous sulfate; iron(II) sulfate, ferrous chloride, ferric nitrate, ferric sulfate, and/or ferric chloride. Various embodiments may further include adding iron ions to the etching solution. Various embodiments may further include adding one or more corrosion inhibitors to the etching solution. Various embodiments may further include recycling the etching solution. Various embodiments may include a method for purifying iron-bearing materials comprising: modifying a species of impurity in an iron-bearing material to be a benign compound. In various embodiments, the impurity is silica and the modifying comprises adding an additive to transform the silica into a silicon compound. In various embodiments, the additive is dolomitic lime. Various embodiments may include a method for purifying an iron-bearing material comprising: passivating an impurity in the iron-bearing material such that passivated impurity no longer reacts with an electrolyte of a battery in which the iron-bearing material will be used. Various embodiments may include a method for purifying an iron-bearing material comprising: adding a co-additive to the iron-bearing material that preferentially reacts with an impurity in the iron-bearing material instead of a stannate added to the iron-bearing material. In various embodiments, the impurity comprises calcium or magnesium. In various embodiments, the co-additive comprises fluoride ions, phosphate ions, and/or carbonate ions. In various embodiments, the purifying of the iron-bearing materials is performed at one or more stages in the processing of iron ore for forming a battery component. In various embodiments, the one or more stages include prior to, during, and/or after milling, blending, adding binders, adding fluxes, filtration, pelletizing, induration, forming iron ore pellets (IOPs), reduction, forming direct reduced iron (DRI) pellets, crushing, pulverizing, heating, hot pressing, and/or forming a battery component. Various embodiments may further include forming an electrode of a battery using the purified iron-bearing materials. Various embodiments may further include providing the battery into a bulk energy storage system. In various embodiments, the bulk energy storage system is a long duration energy storage (LODES) system. Various embodiments may include a battery and/or a bulk energy storage system, comprising at least one electrode formed at least in part according to the operations of the methods of this paragraph.

Various embodiments described and illustrated herein may provide devices and/or methods for use in bulk energy storage systems, such as long duration energy storage (LODES) systems, short duration energy storage (SDES) systems, etc. As an example, various embodiments may provide batteries (e.g., battery 200) for bulk energy storage systems, such as batteries for LODES systems. Renewable power sources are becoming more prevalent and cost effective. However, many renewable power sources face an intermittency problem that is hindering renewable power source adoption. The impact of the intermittent tendencies of renewable power sources may be mitigated by pairing renewable power sources with bulk energy storage systems, such as LODES systems, SDES systems, etc. To support the adoption of combined power generation, transmission, and storage systems (e.g., a power plant having a renewable power generation source paired with a bulk energy storage system and transmission facilities at any of the power plant and/or the bulk energy storage system) devices and methods to support the design and operation of such combined power generation, transmission, and storage systems, such as the various embodiment devices and methods described herein, are needed.

A combined power generation, transmission, and storage system may be a power plant including one or more power generation sources (e.g., one or more renewable power generation sources, one or more non-renewable power generations sources, combinations of renewable and non-renewable power generation sources, etc.), one or more transmission facilities, and one or more bulk energy storage systems. Transmission facilities at any of the power plant and/or the bulk energy storage systems may be co-optimized with the power generation and storage system or may impose constraints on the power generation and storage system design and operation. The combined power generation, transmission, and storage systems may be configured to meet various output goals, under various design and operating constraints.

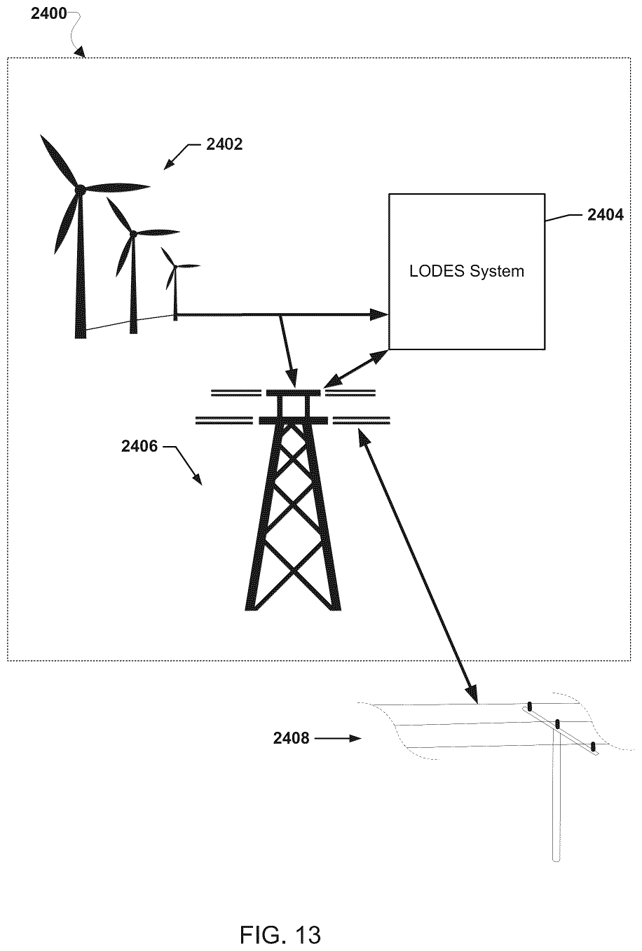

FIGS. 13-21 illustrate various example systems in which one or more aspects of the various embodiments may be used as part of bulk energy storage systems, such as LODES systems, SDES systems, etc. For example, various embodiments described herein with reference to FIGS. 1A-12C may be used as batteries for bulk energy storage systems, such as LODES systems, SDES systems, etc. and/or various electrodes as described herein may be used as components for bulk energy storage systems. As used herein, the term “LODES system” may mean a bulk energy storage system configured to may have a rated duration (energy/power ratio) of 24 hours (h) or greater, such as a duration of 24 h, a duration of 24 h to 50 h, a duration of greater than 50 h, a duration of 24 h to 150 h, a duration of greater than 150 h, a duration of 24 h to 200 h, a duration greater than 200 h, a duration of 24 h to 500 h, a duration greater than 500 h, etc.

FIG. 13 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to a wind farm 2402 and one or more transmission facilities 2406. The wind farm 2402 may be electrically connected to the transmission facilities 2406. The transmission facilities 2406 may be electrically connected to the grid 2408. The wind farm 2402 may generate power and the wind farm 2402 may output generated power to the LODES system 2404 and/or the transmission facilities 2406. The LODES system 2404 may store power received from the wind farm 2402 and/or the transmission facilities 2406. The LODES system 2404 may output stored power to the transmission facilities 2406. The transmission facilities 2406 may output power received from one or both of the wind farm 2402 and LODES system 2404 to the grid 2408 and/or may receive power from the grid 2408 and output that power to the LODES system 2404. Together the wind farm 2402, the LODES system 2404, and the transmission facilities 2406 may constitute a power plant 2400 that may be a combined power generation, transmission, and storage system. The power generated by the wind farm 2402 may be directly fed to the grid 2408 through the transmission facilities 2406, or may be first stored in the LODES system 2404. In certain cases the power supplied to the grid 2408 may come entirely from the wind farm 2402, entirely from the LODES system 2404, or from a combination of the wind farm 2402 and the LODES system 2404. The dispatch of power from the combined wind farm 2402 and LODES system 2404 power plant 2400 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 2400, the LODES system 2404 may be used to reshape and “firm” the power produced by the wind farm 2402. In one such example, the wind farm 2402 may have a peak generation output (capacity) of 260 megawatts (MW) and a capacity factor (CF) of 41%. The LODES system 2404 may have a power rating (capacity) of 106 MW, a rated duration (energy/power ratio) of 150 hours (h), and an energy rating of 15,900 megawatt hours (MWh). In another such example, the wind farm 2402 may have a peak generation output (capacity) of 300 MW and a capacity factor (CF) of 41%. The LODES system 2404 may have a power rating of 106 MW, a rated duration (energy/power ratio) of 200 h and an energy rating of 21,200 MWh. In another such example, the wind farm 2402 may have a peak generation output (capacity) of 176 MW and a capacity factor (CF) of 53%. The LODES system 2404 may have a power rating (capacity) of 88 MW, a rated duration (energy/power ratio) of 150 h and an energy rating of 13,200 MWh. In another such example, the wind farm 2402 may have a peak generation output (capacity) of 277 MW and a capacity factor (CF) of 41%. The LODES system 2404 may have a power rating (capacity) of 97 MW, a rated duration (energy/power ratio) of 50 h and an energy rating of 4,850 MWh. In another such example, the wind farm 2402 may have a peak generation output (capacity) of 315 MW and a capacity factor (CF) of 41%. The LODES system 2404 may have a power rating (capacity) of 110 MW, a rated duration (energy/power ratio) of 25 h and an energy rating of 2,750 MWh.

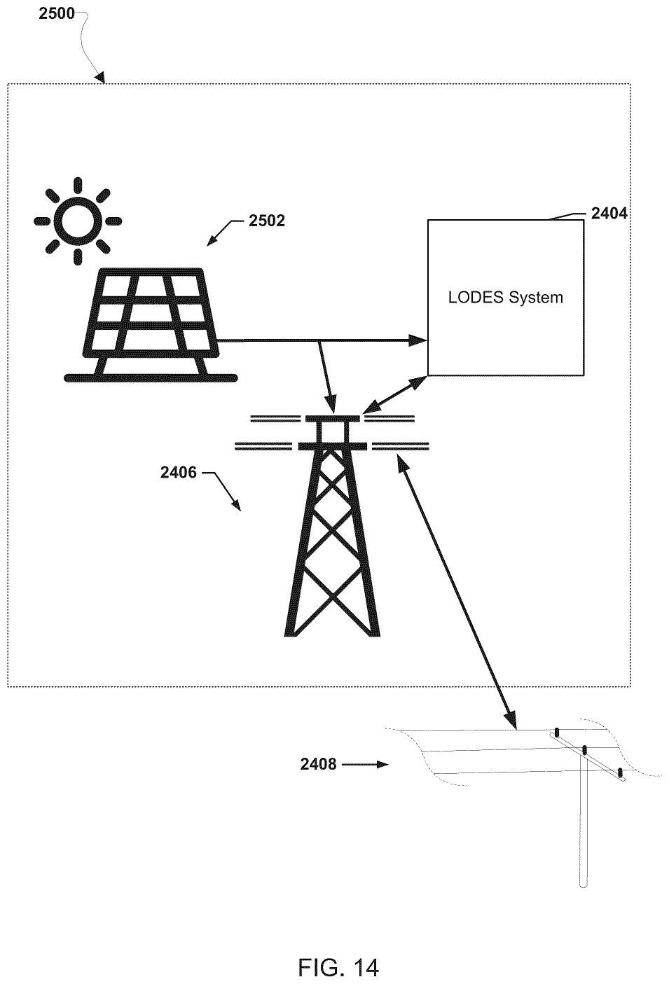

FIG. 14 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The system of FIG. 24 may be similar to the system of FIG. 13, except a photovoltaic (PV) farm 2502 may be substituted for the wind farm 2402. The LODES system 2404 may be electrically connected to the PV farm 2502 and one or more transmission facilities 2406. The PV farm 2502 may be electrically connected to the transmission facilities 2406. The transmission facilities 2406 may be electrically connected to the grid 2408. The PV farm 2502 may generate power and the PV farm 2502 may output generated power to the LODES system 2404 and/or the transmission facilities 2406. The LODES system 2404 may store power received from the PV farm 2502 and/or the transmission facilities 2406. The LODES system 2404 may output stored power to the transmission facilities 2406. The transmission facilities 2406 may output power received from one or both of the PV farm 2502 and LODES system 2404 to the grid 2408 and/or may receive power from the grid 2408 and output that power to the LODES system 2404. Together the PV farm 2502, the LODES system 2404, and the transmission facilities 2406 may constitute a power plant 2500 that may be a combined power generation, transmission, and storage system. The power generated by the PV farm 2502 may be directly fed to the grid 2408 through the transmission facilities 2406, or may be first stored in the LODES system 2404. In certain cases the power supplied to the grid 2408 may come entirely from the PV farm 2502, entirely from the LODES system 2404, or from a combination of the PV farm 2502 and the LODES system 2404. The dispatch of power from the combined PV farm 2502 and LODES system 2404 power plant 2500 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 2500, the LODES system 2404 may be used to reshape and “firm” the power produced by the PV farm 2502. In one such example, the PV farm 2502 may have a peak generation output (capacity) of 490 MW and a capacity factor (CF) of 24%. The LODES system 2404 may have a power rating (capacity) of 340 MW, a rated duration (energy/power ratio) of 150 h and an energy rating of 51,000 MWh. In another such example, the PV farm 2502 may have a peak generation output (capacity) of 680 MW and a capacity factor (CF) of 24%. The LODES system 2404 may have a power rating (capacity) of 410 MW, a rated duration (energy/power ratio) of 200 h, and an energy rating of 82,000 MWh. In another such example, the PV farm 2502 may have a peak generation output (capacity) of 330 MW and a capacity factor (CF) of 31%. The LODES system 2404 may have a power rating (capacity) of 215 MW, a rated duration (energy/power ratio) of 150 h, and an energy rating of 32,250 MWh. In another such example, the PV farm 2502 may have a peak generation output (capacity) of 510 MW and a capacity factor (CF) of 24%. The LODES system 2404 may have a power rating (capacity) of 380 MW, a rated duration (energy/power ratio) of 50 h, and an energy rating of 19,000 MWh. In another such example, the PV farm 2502 may have a peak generation output (capacity) of 630 MW and a capacity factor (CF) of 24%. The LODES system 2404 may have a power rating (capacity) of 380 MW, a rated duration (energy/power ratio) of 25 h, and an energy rating of 9,500 MWh.

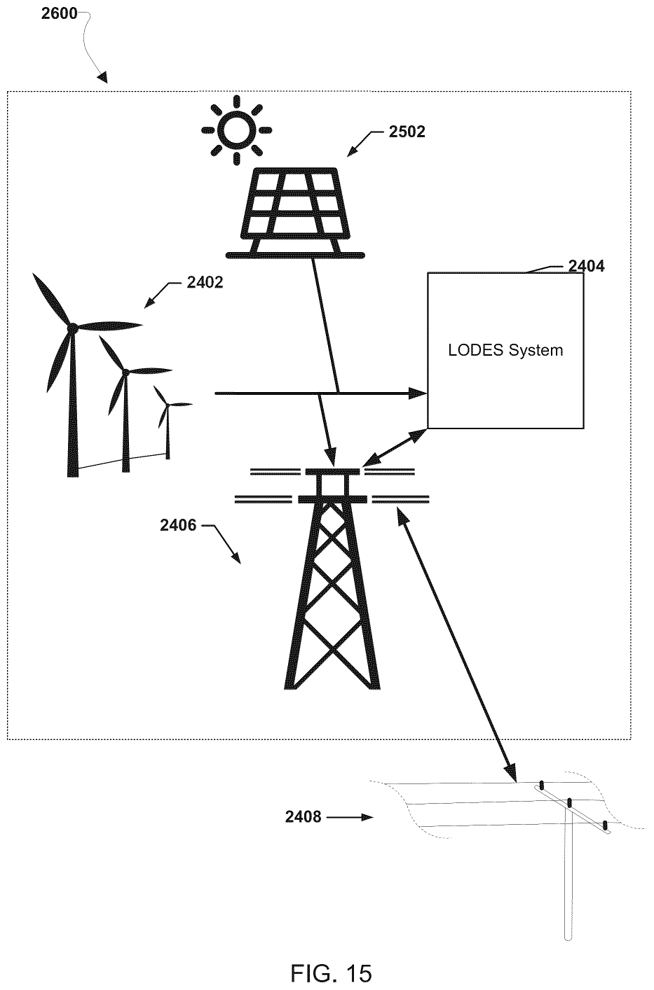

FIG. 15 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The system of FIG. 15 may be similar to the systems of FIGS. 13 and 14, except the wind farm 2402 and the photovoltaic (PV) farm 2502 may both be power generators working together in the power plant 2600. Together the PV farm 2502, wind farm 2402, the LODES system 2404, and the transmission facilities 2406 may constitute the power plant 2600 that may be a combined power generation, transmission, and storage system. The power generated by the PV farm 2502 and/or the wind farm 2402 may be directly fed to the grid 2408 through the transmission facilities 2406, or may be first stored in the LODES system 2404. In certain cases the power supplied to the grid 2408 may come entirely from the PV farm 2502, entirely from the wind farm 2402, entirely from the LODES system 2404, or from a combination of the PV farm 2502, the wind farm 2402, and the LODES system 2404. The dispatch of power from the combined wind farm 2402, PV farm 2502, and LODES system 2404 power plant 2600 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 2600, the LODES system 2404 may be used to reshape and “firm” the power produced by the wind farm 2402 and the PV farm 2502. In one such example, the wind farm 2402 may have a peak generation output (capacity) of 126 MW and a capacity factor (CF) of 41% and the PV farm 2502 may have a peak generation output (capacity) of 126 MW and a capacity factor (CF) of 24%. The LODES system 2404 may have a power rating (capacity) of 63 MW, a rated duration (energy/power ratio) of 150 h, and an energy rating of 9,450 MWh. In another such example, the wind farm 2402 may have a peak generation output (capacity) of 170 MW and a capacity factor (CF) of 41% and the PV farm 2502 may have a peak generation output (capacity) of 110 MW and a capacity factor (CF) of 24%. The LODES system 2404 may have a power rating (capacity) of 57 MW, a rated duration (energy/power ratio) of 200 h, and an energy rating of 11,400 MWh. In another such example, the wind farm 2402 may have a peak generation output (capacity) of 105 MW and a capacity factor (CF) of 51% and the PV farm 2502 may have a peak generation output (capacity) of 70 MW and a capacity factor (CF) of 31 The LODES system 2404 may have a power rating (capacity) of 61 MW, a rated duration (energy/power ratio) of 150 h, and an energy rating of 9,150 MWh. In another such example, the wind farm 2402 may have a peak generation output (capacity) of 135 MW and a capacity factor (CF) of 41% and the PV farm 2502 may have a peak generation output (capacity) of 90 MW and a capacity factor (CF) of 24%. The LODES system 2404 may have a power rating (capacity) of 68 MW, a rated duration (energy/power ratio) of 50 h, and an energy rating of 3,400 MWh. In another such example, the wind farm 2402 may have a peak generation output (capacity) of 144 MW and a capacity factor (CF) of 41% and the PV farm 2502 may have a peak generation output (capacity) of 96 MW and a capacity factor (CF) of 24%. The LODES system 2404 may have a power rating (capacity) of 72 MW, a rated duration (energy/power ratio) of 25 h, and an energy rating of 1,800 MWh.

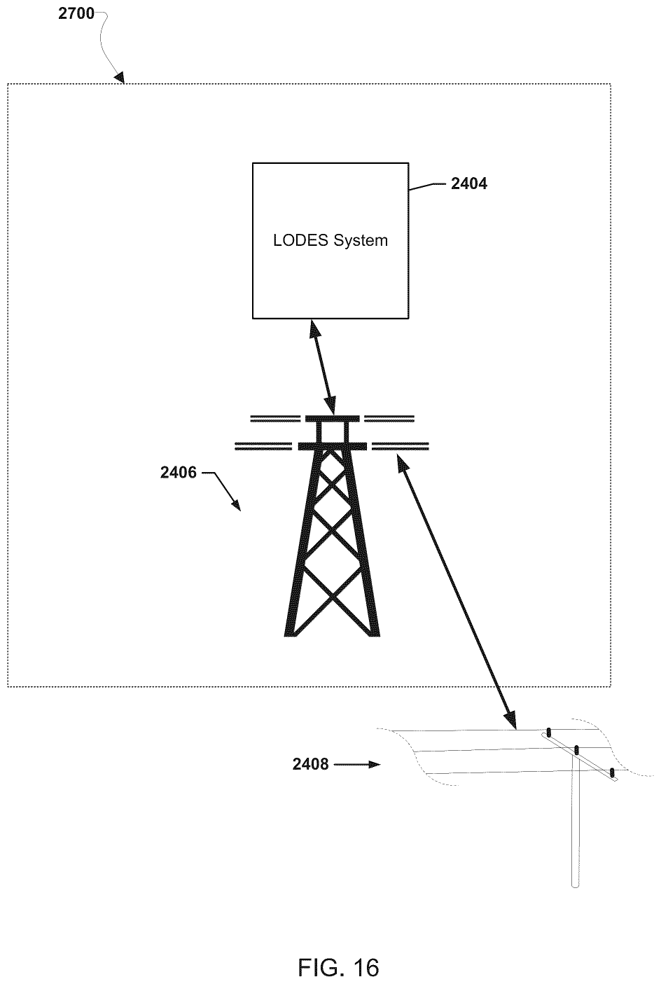

FIG. 16 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to one or more transmission facilities 2406. In this manner, the LODES system 2404 may operate in a “stand-alone” manner to arbiter energy around market prices and/or to avoid transmission constraints. The LODES system 2404 may be electrically connected to one or more transmission facilities 2406. The transmission facilities 2406 may be electrically connected to the grid 2408. The LODES system 2404 may store power received from the transmission facilities 2406. The LODES system 2404 may output stored power to the transmission facilities 2406. The transmission facilities 2406 may output power received from the LODES system 2404 to the grid 2408 and/or may receive power from the grid 2408 and output that power to the LODES system 2404.

Together the LODES system 2404 and the transmission facilities 2406 may constitute a power plant 900. As an example, the power plant 900 may be situated downstream of a transmission constraint, close to electrical consumption. In such an example downstream situated power plant 2700, the LODES system 2404 may have a duration of 24 h to 500 h and may undergo one or more full discharges a year to support peak electrical consumptions at times when the transmission capacity is not sufficient to serve customers. Additionally in such an example downstream situated power plant 2700, the LODES system 2404 may undergo several shallow discharges (daily or at higher frequency) to arbiter the difference between nighttime and daytime electricity prices and reduce the overall cost of electrical service to customer. As a further example, the power plant 2700 may be situated upstream of a transmission constraint, close to electrical generation. In such an example upstream situated power plant 2700, the LODES system 2404 may have a duration of 24 h to 500 h and may undergo one or more full charges a year to absorb excess generation at times when the transmission capacity is not sufficient to distribute the electricity to customers. Additionally in such an example upstream situated power plant 2700, the LODES system 2404 may undergo several shallow charges and discharges (daily or at higher frequency) to arbiter the difference between nighttime and daytime electricity prices and maximize the value of the output of the generation facilities.

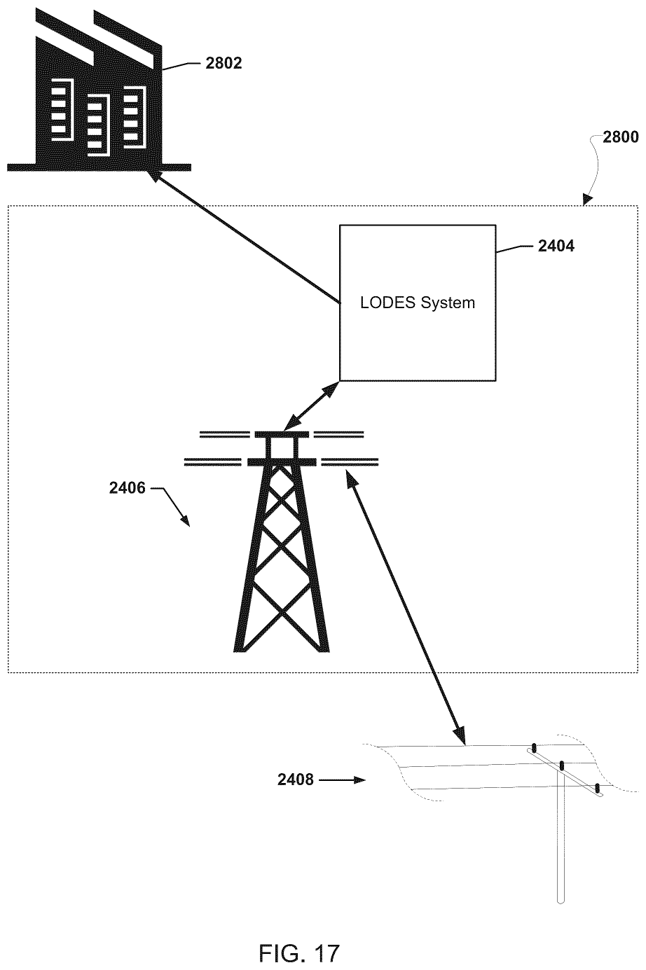

FIG. 17 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to a commercial and industrial (C&I) customer 2802, such as a data center, factory, etc. The LODES system 2404 may be electrically connected to one or more transmission facilities 2406. The transmission facilities 2406 may be electrically connected to the grid 2408. The transmission facilities 2406 may receive power from the grid 2408 and output that power to the LODES system 2404. The LODES system 2404 may store power received from the transmission facilities 2406. The LODES system 2404 may output stored power to the C&I customer 2802. In this manner, the LODES system 2404 may operate to reshape electricity purchased from the grid 2408 to match the consumption pattern of the C&I customer 2802.

Together, the LODES system 2404 and transmission facilities 2406 may constitute a power plant 2800. As an example, the power plant 2800 may be situated close to electrical consumption, i.e., close to the C&I customer 2802, such as between the grid 2408 and the C&I customer 2802. In such an example, the LODES system 2404 may have a duration of 24 h to 500 h and may buy electricity from the markets and thereby charge the LODES system 2404 at times when the electricity is cheaper. The LODES system 2404 may then discharge to provide the C&I customer 2802 with electricity at times when the market price is expensive, therefore offsetting the market purchases of the C&I customer 2802. As an alternative configuration, rather than being situated between the grid 2408 and the C&I customer 2802, the power plant 2800 may be situated between a renewable source, such as a PV farm, wind farm, etc., and the transmission facilities 2406 may connect to the renewable source. In such an alternative example, the LODES system 2404 may have a duration of 24 h to 500 h, and the LODES system 2404 may charge at times when renewable output may be available. The LODES system 2404 may then discharge to provide the C&I customer 2802 with renewable generated electricity so as to cover a portion, or the entirety, of the C&I customer 2802 electricity needs.

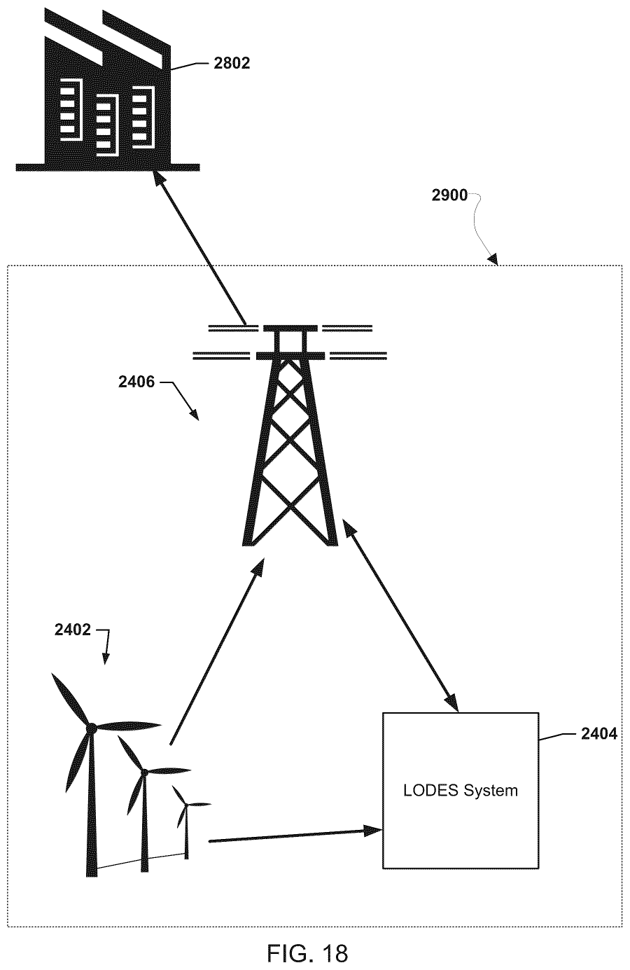

FIG. 18 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be electrically connected to a wind farm 2402 and one or more transmission facilities 2406. The wind farm 2402 may be electrically connected to the transmission facilities 2406. The transmission facilities 2406 may be electrically connected to a C&I customer 2802. The wind farm 2402 may generate power and the wind farm 2402 may output generated power to the LODES system 2404 and/or the transmission facilities 2406. The LODES system 2404 may store power received from the wind farm 2402.

The LODES system 2404 may output stored power to the transmission facilities 2406. The transmission facilities 2406 may output power received from one or both of the wind farm 2402 and LODES system 2404 to the C&I customer 2802. Together the wind farm 2402, the LODES system 2404, and the transmission facilities 2406 may constitute a power plant 2900 that may be a combined power generation, transmission, and storage system. The power generated by the wind farm 2402 may be directly fed to the C&I customer 2802 through the transmission facilities 2406, or may be first stored in the LODES system 2404. In certain cases, the power supplied to the C&I customer 2802 may come entirely from the wind farm 2402, entirely from the LODES system 2404, or from a combination of the wind farm 2402 and the LODES system 2404. The LODES system 2404 may be used to reshape the electricity generated by the wind farm 2402 to match the consumption pattern of the C&I customer 2802. In one such example, the LODES system 2404 may have a duration of 24 h to 500 h and may charge when renewable generation by the wind farm 2402 exceeds the C&I customer 2802 load. The LODES system 2404 may then discharge when renewable generation by the wind farm 2402 falls short of C&I customer 2802 load so as to provide the C&I customer 2802 with a firm renewable profile that offsets a fraction, or all of, the C&I customer 2802 electrical consumption.

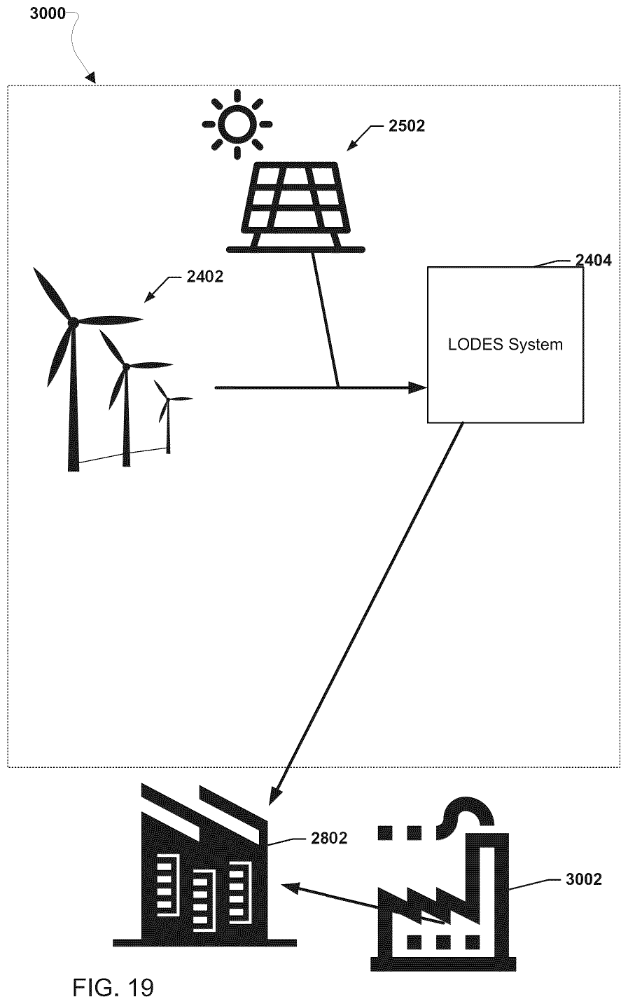

FIG. 19 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be part of a power plant 3000 that is used to integrate large amounts of renewable generation in microgrids and harmonize the output of renewable generation by, for example a PV farm 2502 and wind farm 2402, with existing thermal generation by, for example a thermal power plant 3002 (e.g., a gas plant, a coal plant, a diesel generator set, etc., or a combination of thermal generation methods), while renewable generation and thermal generation supply the C&I customer 2802 load at high availability. Microgrids, such as the microgrid constituted by the power plant 3000 and the thermal power plant 3002, may provide availability that is 90% or higher. The power generated by the PV farm 2502 and/or the wind farm 2402 may be directly fed to the C&I customer 2802, or may be first stored in the LODES system 2404.

In certain cases the power supplied to the C&I customer 2802 may come entirely from the PV farm 2502, entirely from the wind farm 2402, entirely from the LODES system 2404, entirely from the thermal power plant 3002, or from any combination of the PV farm 2502, the wind farm 2402, the LODES system 2404, and/or the thermal power plant 3002. As examples, the LODES system 2404 of the power plant 3000 may have a duration of 24 h to 500 h. As a specific example, the C&I customer 2802 load may have a peak of 100 MW, the LODES system 2404 may have a power rating of 14 MW and duration of 150 h, natural gas may cost $6/million British thermal units (MMBTU), and the renewable penetration may be 58%. As another specific example, the C&I customer 2802 load may have a peak of 100 MW, the LODES system 2404 may have a power rating of 25 MW and duration of 150 h, natural gas may cost $8/MMBTU, and the renewable penetration may be 65%.

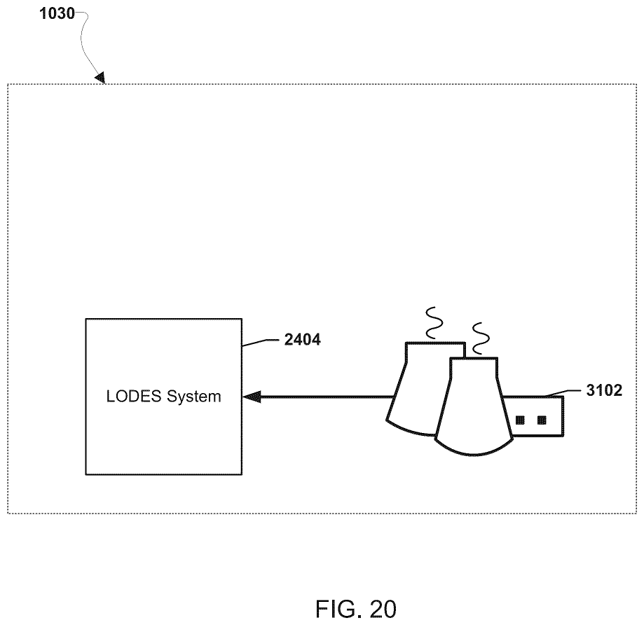

FIG. 20 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may be used to augment a nuclear plant 3102 (or other inflexible generation facility, such as a thermal, a biomass, etc., and/or any other type plant having a ramp-rate lower than 50% of rated power in one hour and a high capacity factor of 80% or higher) to add flexibility to the combined output of the power plant 3100 constituted by the combined LODES system 2404 and nuclear plant 3102. The nuclear plant 3102 may operate at high capacity factor and at the highest efficiency point, while the LODES system 2404 may charge and discharge to effectively reshape the output of the nuclear plant 3102 to match a customer electrical consumption and/or a market price of electricity. As examples, the LODES system 2404 of the power plant 3100 may have a duration of 24 h to 500 h. In one specific example, the nuclear plant 3102 may have 1,000 MW of rated output and the nuclear plant 3102 may be forced into prolonged periods of minimum stable generation or even shutdowns because of depressed market pricing of electricity. The LODES system 2404 may avoid facility shutdowns and charge at times of depressed market pricing; and the LODES system 2404 may subsequently discharge and boost total output generation at times of inflated market pricing.

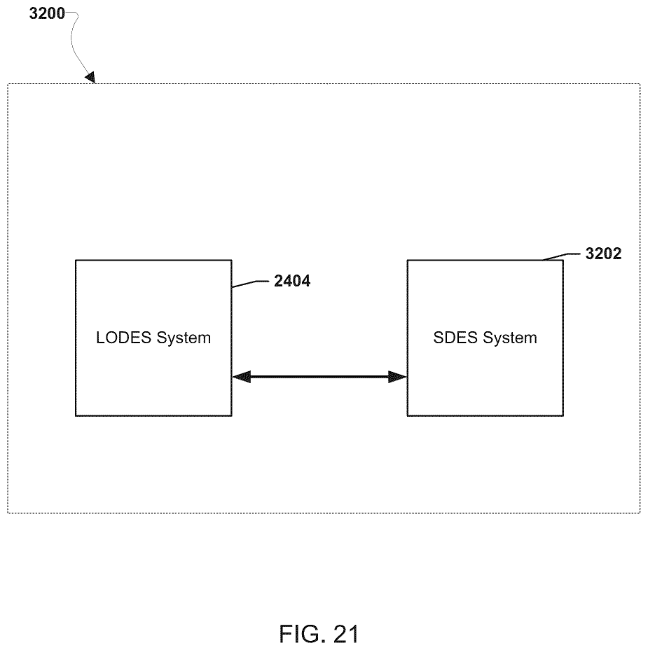

FIG. 21 illustrates an example system in which one or more aspects of the various embodiments may be used as part of bulk energy storage system. As a specific example, the bulk energy storage system incorporating one or more aspects of the various embodiments may be a LODES system 2404. As an example, the LODES system 2404 may include various embodiment batteries described herein, various electrodes described herein, etc. The LODES system 2404 may operate in tandem with a SDES system 3202. Together the LODES system 2404 and SDES system 3202 may constitute a power plant 3200. As an example, the LODES system 2404 and SDES system 3202 may be co-optimized whereby the LODES system 2404 may provide various services, including long-duration back-up and/or bridging through multi-day fluctuations (e.g., multi-day fluctuations in market pricing, renewable generation, electrical consumption, etc.), and the SDES system 3202 may provide various services, including fast ancillary services (e.g. voltage control, frequency regulation, etc.) and/or bridging through intra-day fluctuations (e.g., intra-day fluctuations in market pricing, renewable generation, electrical consumption, etc.). The SDES system 3202 may have durations of less than 10 hours and round-trip efficiencies of greater than 80%. The LODES system 2404 may have durations of 24 h to 500 h and round-trip efficiencies of greater than 40%. In one such example, the LODES system 2404 may have a duration of 150 hours and support customer electrical consumption for up to a week of renewable under-generation. The LODES system 2404 may also support customer electrical consumption during intra-day under-generation events, augmenting the capabilities of the SDES system 3202. Further, the SDES system 3202 may supply customers during intra-day under-generation events and provide power conditioning and quality services such as voltage control and frequency regulation.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the described embodiment. Various modifications to these embodiments will be readily apparent to those skilled in the art, and the generic principles defined herein may be applied to other embodiments without departing from the scope of the disclosure. Thus, the present invention is not intended to be limited to the embodiments shown herein but is to be accorded the widest scope consistent with the following claims and the principles and novel features disclosed herein.

1. A method of metallurgical processing, the method comprising:
leaching one or more soluble species of impurities out of iron-bearing materials wherein leaching the one or more soluble species of impurities comprises leaching with a leaching solution comprising a fluorine containing component.

2. The method of claim 1, wherein the leaching solution comprises ammonium fluoride (NH₄F) or acid ammonium fluoride (3NH₄·HF₂), or mixtures thereof.

3. The method of claim 1, wherein the leaching solution comprises ammonium bifluoride (NH₄HF₂).

4. The method of claim 1, wherein leaching the one or more soluble species of the impurities out of the iron-bearing materials comprises dissolving the one or more species of the impurities using hydrofluoric acid (HF), alkali metal hydroxides, molten chlorides, molten fluorides, and/or molten oxides.

5. The method of claim 1, wherein the leaching solution comprises sodium fluorophosphate (Na₂PO₃F).

6. The method of claim 1, wherein the fluorine containing component of the leaching solution has a molar concentration between 100 and 10000 ppm.

7. The method of claim 6, wherein the fluorine containing component of the leaching solution has a molar concentration between 500 and 5000 ppm.

8. The method of claim 1, wherein the iron-bearing materials are iron ores, iron, and/or intermediates thereof.

9. The method of claim 1, further comprising controlling a pH of the leaching solution.

10. The method of claim 9, wherein the pH is controlled to be in a range of 8 to 13.

11. The method of claim 10, wherein the pH is controlled to be in a range of 7 to 9.

12. The method of claim 11, wherein the pH is controlled to be in a range of 5 to 10.

13. The method of claim 1, further comprising adding a soluble iron salt to the leaching solution.

14. The method of claim 13, wherein the soluble iron salt comprises one or more of ferrous sulfate, iron(II) sulfate, ferrous chloride, ferric nitrate, ferric sulfate, and/or ferric chloride.

15. The method of claim 1, further comprising adding iron ions to the leaching solution.

16. The method of claim 1, further comprising adding one or more corrosion inhibitors to the leaching solution.

17. The method of claim 1, further comprising recycling the leaching solution.

18. A method of metallurgical processing, the method comprising:
leaching one or more soluble species of impurities out of iron-bearing materials,
wherein leaching the one or more soluble species of impurities comprises dissolution of the one or more soluble species of impurities via addition of a flux.

19. The method of claim 1, further comprising forming an electrode of a battery using the iron-bearing materials from which the one or more soluble species of impurities have been leached.

20. The method of claim 19, further comprising providing the battery into a bulk energy storage system.

21. The method of claim 20, wherein the bulk energy storage system is a long duration energy storage (LODES) system.

22. A battery and/or a bulk energy storage system, comprising at least one electrode formed at least in part according to claim 1.
